(19) United States
(12) Patent Application Publication
(10) Pub. No.: US 2025/0154999 A1
(43) Pub. Date: May 15, 2025

(54) DAMPING DEVICE FOR A FURNITURE OR BUILDING FITTING

(71) Applicant: Julius Blum GmbH, Hoechst (AT)

(72) Inventor: Philip SCHLUGE, Dornbirn (AT)

(21) Appl. No.: 19/025,050

(22) Filed: Jan. 16, 2025

Related U.S. Application Data
(63) Continuation of application No. PCT/AT2023/060214, filed on Jul. 5, 2023.

(30) Foreign Application Priority Data
Jul. 26, 2022 (AT) A 50562/2022

(51) Int. Cl. F16F 13/00; A47B 97/00; E05F 5/02

(52) U.S. Cl. CPC F16F 13/007; E05F 5/02; A47B 97/00; E05Y 2201/256; E05Y 2201/264; E05Y 2201/474; E05Y 2900/132; E05Y 2900/148; E05Y 2900/20; F16F 2222/06; F16F 2228/066; F16F 2228/08; F16F 2230/18; F16F 2230/30; F16F 2230/36; F16F 2230/42

(57) ABSTRACT

A damping device includes a cylinder having a damping fluid, and a piston to be actuated via a piston rod and movable through the damping fluid during a damping stroke. A flow channel allows the damping fluid to pass through the piston during the damping stroke. A control piston is mounted in/on the piston to be movable, and a cross section of the flow channel is changeable by a movement of the control piston relative to the piston. A force accumulator can move the control piston relative to the piston with a return force counteracting a flow force exerted by the damping fluid on the control piston during the damping stroke. A control aperture allows a pressure drop proportional to the flow force and the speed of the piston to occur, and a target speed for the piston is dependent on a position of the piston relative to the cylinder.

The present application is a continuation of International Application PCT/AT2023/060214 filed on Jul. 5, 2023. Thus, all of the subject matter of International Application PCT/AT2023/060214 is incorporated herein by reference.

### BACKGROUND OF THE INVENTION

The invention relates to a damping device. Furthermore, the invention relates to a method for controlling a movement of a movable furniture part by regulating a damping speed by way of at least one such damping device. Furthermore, the invention relates to a use of such a damping device as well as to a piece of furniture, a door, and a window having at least one such damping device.

A damping device is already known from DE 20 2011 108 658 U1, which uses a volume keeping-constant element in the form of a flying seal having a groove control in a return flow area of a damping fluid in order to enable a design of the groove adapted to the volume change caused by a sealing element and a uniform damping characteristic.

A disadvantage of the prior art is that the damping device cannot be flexibly adjusted to changing conditions of furniture, since different dimensions of the movable furniture part, different movement trajectories and/or movement sequences result in varying damping characteristics. The damping device in particular has to be individually adapted to each specific requirement in use and each specific piece of furniture via the structural design, such as a geometry of the groove. Since the damping device always regulates a speed of the movable furniture part to zero, no constant damping behavior is generated with different movable furniture parts and/or varying speeds of the movable furniture part, since the damping device is dependent on the dimensioning (and/or speed of the movable furniture part).

### SUMMARY OF THE INVENTION

The objective technical problem of the present invention is therefore to specify a damping device which is improved in relation to the prior art and a method for controlling a movement of a movable furniture part, in which the disadvantages of the prior art are at least partially eliminated, and which is characterized in particular by a constant damping behavior or a constant damping characteristic—independently of a dimensioning and/or speed of a movable furniture part.

Therefore, according to the invention, at least one control piston is provided which is mounted in and/or on the piston so as to be movable, preferably displaceable, and the flow cross section of the at least one flow channel is changeable by a movement of the at least one control piston relative to the piston. At least one force accumulator, preferably a return spring, applies a return force to the at least one control piston relative to the piston, which counteracts at least one flow force which can be exerted on the at least one control piston by the damping fluid during the damping stroke. At least one control aperture is provided at which a pressure drop proportional to the flow force and the speed of the piston takes place, and a target speed for the piston is predetermined which depends on a position of the piston relative to the cylinder. The at least one control piston is movable relative to the piston against the return force at a speed of the piston which is greater than the target speed in such a way that the flow cross section of the at least one flow channel is reducible. Preferably, the target speed for the piston, which is dependent on the position of the piston relative to the cylinder, is predetermined by
at least one further force accumulator, particularly preferably a spring, which applies a force to the at least one control piston counter to the return force, and/or
by an adjustability of an aperture opening of the at least one control aperture and/or
by at least one groove in a cylinder inner wall having a changing groove cross section.

This makes it possible for the first time for the damping device to comprise an automatic control via the at least one control piston—in particular due to a pressure and/or force ratio and/or initiated by a control signal for the at least one control piston on the at least one control aperture and/or on at least one braking element—using which stronger and weaker damping effects can be generated individually depending on the forces acting on the piston rod, which result in a particularly harmonious damping curve of movable furniture parts—even if the forces acting on the movable furniture part and/or the damping device vary greatly. A speed of the movable furniture part thus steadily or continuously approaches a desired speed profile, which is defined, for example, by at least one further force accumulator acting between the cylinder and the piston, wherein this fact is independent of the mass of the movable furniture part and/or a force transmission by a closing mechanism to the damping device.

In addition, in particular in the case of changed piston speeds and/or a changed dimensioning of the movable furniture part, an adjustment to an (arbitrarily defined) desired speed profile of the damping device can be carried out in the sense of a uniform damping characteristic or a constant damping behavior.

This allows an automatic adjustment of a differential speed to the desired speed profile of the piston relative to the cylinder at varying piston speeds relative to the cylinder in order to ensure a constant and/or harmonious damping force during the damping stroke both at excessive and undesirably low speeds of the piston.

A damper control is particularly preferably carried out in relation to the piston relative to the cylinder in a speed-dependent manner, wherein alternatively or additionally a path-dependent control can also be provided in order in particular to automatically adapt a damping behavior to varying dimensions and/or speeds of movable parts.

If the speed of the piston or the movable furniture part (or window or door) is below a target speed defined by the structural design of the damping device, the damping device can be automatically switched to inactive so that the piston and/or the movable furniture part is not decelerated—until the speed rises above the target speed.

Furthermore, an adjustment to a speed reference curve can be made both when the speed of the piston is too high and when it is too low, by which a particularly user-friendly handling of furniture having such a damping device can be ensured by harmonious and consistent movement sequences.

In addition, the damping device can be used on a wider spectrum of movable furniture parts without any structural modifications being necessary. For example, a damping device according to the invention can serve a broader performance spectrum and/or can be flexibly adapted to new areas of requirements via a suitable selection of force accumulators in the damping device.

Furthermore, the damping device exhibits a more advantageous bounce behavior, wherein in particular damage to component parts is effectively prevented, since the damping performance is essentially non-existent when the desired reference speed of the piston relative to the cylinder is reached in the region of a closed position of the movable furniture part and/or in general a bounce range of the damping device is arranged at a safety distance from the operating range of the damping device. Damage is therefore inhibited or prevented even if furniture is used improperly. In addition, the damping device makes closing times from an at least partially open position of the movable furniture part to the closed position of the movable furniture part more constant, since when the speed falls below the reference speed of the piston relative to the cylinder, essentially no damping is generated by the damping device and thus the movable furniture part can make up usable time in a temporal course of the movement of the movable furniture part.

Furthermore, in arrangements made up of at least one damping device and a closing device, a closing force of the closing device can be reduced, by which the haptics for a user of the arrangement are improved.

The flow of the damping fluid through the inlet opening of the piston is related to the speed of the piston relative to the cylinder and creates a pressure drop in the front region. For example, this pressure drop can be converted into a displacement of at least one control piston with the aid of a pressure compensator, wherein a spring preload of at least one further force accumulator acting on the piston can function as a reference speed. Depending on a position of the at least one control piston along a movement path of the at least one control piston relative to the piston, a power valve can be achieved which determines the flow cross section of the damping fluid flowing through the outlet opening of the piston.

Depending on the flow cross section, a pressure of the damping fluid results in the front region, wherein this pressure determines the damping force of the damping device and thus the damping performance.

In other words, a control signal (for example via a fluid flow across a braking element and/or the at least one control aperture) for the power signal at the power valve in the form of the at least one control piston in interaction with the piston (arranged on the outside or inside) can be generated via force/pressure ratios—caused by a degree of fluid flowing through the at least one control aperture, spring forces, etc.—wherein, for example, a change in the flow cross section is generated via an overlap or a cross section change of the at least one flow channel.

In addition, there is the positive property that the damping device can be designed compactly thanks to the at least one control piston, is low-maintenance with a particularly long service life, can be flexibly adapted to different requirements, does not require any complex components, and is economically viable and enables user-friendly installation.

The advantage of this structural design is that the damping performance is achieved via the at least one control piston in the sense of a controlled throttle (function of the speed or function of the pressure difference), in contrast to a pure position dependency of the piston in the cylinder (for example via grooves in the damper) and a pure speed dependency of the piston in the cylinder (for example via a throttle in interaction with the piston). The speed dependence of the damping performance can depend on the position of the at least one control piston in the cylinder, due to which the speed profile can be changed depending on the path of the at least one control piston. If there is an increased pressure, a damping force acts in such a way that the pressure is subsequently reduced. The speed dependence can be translated into a pressure dependence, wherein the piston speed can result in a cross section achieved by the at least one control piston, which is variable. Preferably, a pressure-dependent control aperture is used and/or a path-dependent counterforce is generated.

The power valve can generally be designed to be connected in parallel and/or in series with the at least one control aperture and/or a braking element. In general, outlet openings and/or inlet openings or the flow cross section can refer to the at least one control piston, the at least one control aperture, and/or the piston (in the sense of a kinematic reversal).

As stated at the outset, protection is also sought for a method for controlling a movement of a movable furniture part via regulation of a damping speed by at least one damping device. At a speed of the movable furniture part relative to the at least one damping device and/or at a speed of the piston relative to the cylinder which is greater than the target speed, the at least one control piston is moved relative to the piston against the return force in such a way that the flow cross section of the at least one flow channel is reduced and the movable furniture part and/or the piston is decelerated to the target speed, and the at least one damping device is inactive at a speed which is less than the target speed.

The basic concept of the invention is to adjust a predefined desired speed profile of the damping device depending on a damping path of a movable furniture part. This can be achieved by the damping device generating a damping force depending on a speed difference from the desired speed profile, wherein the desired speed profile particularly preferably represents a linear speed curve having constant slope. In other words, it can be ensured that the damping device automatically and/or continuously approaches or adjusts to the predefined speed profile. If a speed difference is negative—i.e. if the current speed of the piston relative to the cylinder is below the desired speed—the damping device can prevent a damping force.

For example, the at least one control piston can be moved against a force application by at least one further force accumulator—due to a pressure of the damping fluid on the at least one control piston—into a relative position with respect to the piston in which the damping fluid can flow through the piston essentially without resistance. A maximum damping effect with respect to a damping stroke section can be achieved in that relative position in which no overlap is present between the at least one fluid outlet opening and the at least one outlet opening, so that the movement of the piston in the cylinder is only determined by the compressibility of the damping fluid.

In the context of the invention, overlap is understood to mean an intersection of an outlet region of the at least one fluid outlet opening of the at least one control piston with an inlet region of the at least one outlet opening of the piston (and vice versa), which determines a flow cross section for the damping fluid between the at least one control piston and the piston. However, a cross section of the fluid outlet opening and/or the outlet opening can change from an inlet region of the at least one fluid outlet opening or up to an outlet region of the at least one outlet opening, wherein this situation can be controlled in the control via the positioning of the at least one control piston relative to the piston by the specific pressure conditions of the damping device. The cross sections of the outlet region of the at least one fluid outlet opening and the inlet region of the at least one outlet opening can generally be different; however, they are particularly preferably designed to be the same size and/or in the form of a cylindrical opening or bore.

The damping fluid can generally be in the form of a gas and/or a liquid, wherein damping fluids in the liquid phase are particularly preferably used. The damping device can be designed as a pneumatic and/or hydraulic device.

The at least one control aperture and/or the at least one control piston can have a fixed, a position-dependent, and/or a speed-dependent passage cross section. For example, the passage cross section can be adjusted via rotation of the at least one control aperture relative to the piston.

As stated at the beginning, protection is also sought for the use of such a damping device on a movable furniture part, a door, and/or a window.

As stated at the outset, protection is also sought for a piece of furniture having at least one such damping device, wherein at least one movable furniture part can be damped relative to a furniture body by the at least one damping device between an open position and a closed position.

As stated at the outset, protection is also sought for a door having at least one such damping device, wherein the door can be damped relative to a door frame by the at least one damping device between an open position and a closed position.

As stated at the outset, protection is also sought for a window having at least one such damping device, wherein the window can be damped relative to a window frame by the at least one damping device between an open position and a closed position.

In general, the damping effect can act in the direction of the closed position and/or in the direction of the open position. The damping device offers the advantage that a damping stroke can be caused over a large angular range of the part to be damped. Conventional damping devices are designed to damp the range shortly before a closed position in the range of approximately 20°. The damping device according to the invention, on the other hand, can damp angular ranges over 90°, wherein, in particular, the interaction between the at least one control aperture and the at least one flow channel can reduce an increased expenditure of force for moving the part and/or the damping device can be made essentially inactive by the damping cross section. The user of the part therefore generally does not have to work against the damping device, preferably over defined angular ranges, wherein a range before the closed position can be effectively damped, preferably depending on a speed of the piston.

Particularly preferably, the at least one control piston is arranged on the outside of the piston and/or inside the piston and/or is in the form of a power valve of the piston, wherein it is preferably provided that the flow cross section of the at least one flow channel is changeable via the at least one control aperture and/or by the at least one control piston, so that a speed of the piston can be regulated.

The at least one control piston can be movable translationally relative to the piston and/or can be actuated via at least one control aperture movable translationally and/or rotationally relative to the cylinder.

In a preferred embodiment of the invention, the at least one control piston is preloaded by at least one further force accumulator and/or the at least one force accumulator relative to the piston and/or the piston can be subjected to force by at least one further force accumulator.

By means of the at least one further force accumulator, a speed reference curve for a desired target speed curve of the piston and/or the movable furniture part can be adjusted via a force ratio acting on the piston. Alternatively or additionally, the speed reference curve can also be adapted in other ways—for example via a position-dependent groove cross section in the cylinder or a spring constant of the force accumulator in interaction with the at least one control piston.

Preferably, the piston comprises at least one inlet opening facing toward a front region of a fluid chamber arranged on the side of the piston facing away from the piston rod and at least one outlet opening facing toward a rear region of the fluid chamber arranged on the side of the piston facing toward the piston rod. The at least one control piston comprises at least one fluid inlet opening facing toward the front region of the fluid chamber, and at least one fluid outlet opening facing toward the rear region of the fluid chamber. Damping fluid can flow from the front region of the fluid chamber into the rear region of the fluid chamber via the at least one fluid outlet opening and the at least one outlet opening during a damping stroke of the damping device.

By changing the location of the piston and/or the at least one control piston in the cylinder, the inlet opening and the outlet opening can generally be interchanged. In general, it is relevant here that the fluid flow in the flow cross section of the at least one flow channel is controlled by a differential speed—in particular via the interaction between the at least one control piston and the at least one control aperture.

According to an advantageous embodiment of the invention, the at least one control piston is arranged completely inside or completely outside the piston, and preferably at least one stop, preferably facing toward a front region, for the at least one control piston is arranged on the piston.

A complete arrangement within the piston promotes a compact damping device, and relative pressure differences between an outer chamber of the piston and/or the at least one control piston can be used particularly advantageously to control a relative location of the at least one control piston with respect to the piston. When arranged completely outside the piston, a particularly favorable force transmission can be achieved to provide an overlap of openings along the flow cross section required for the desired speed of the piston.

The at least one stop secures the at least one control piston against an undesired exit from the piston and/or limits a movement path of the at least one control piston relative to the piston. For example, the at least one stop can be arranged displaceably and/or rotatably on the piston to simplify the assembly of the at least one control piston. However, a stop that is materially bonded to the piston is also conceivable.

In general, the at least one control piston can also be arranged in some regions on the outside/inside of the piston. Path-dependent grooves such as flow grooves are also conceivable. For example, by twisting or compression, a reduced/increased flow cross section can be generated for a reduced/increased damping performance.

Advantageously, a speed of the piston during the damping stroke relative to the cylinder can be regulated by an overlap at the flow cross section of the at least one flow channel, preferably a possibly present fluid outlet opening with a possibly present outlet opening. Preferably, the overlap defines a flow cross section of the damping fluid and/or the flow cross section is changeable by a relative position of the at least one control piston with respect to the piston.

By way of the overlap and the resulting flow cross section for the damping fluid (generally, for example, starting from the front region into the rear region of the fluid chamber), a power valve can be defined which enables an automatic and continuous change of the damping force and/or the speed of the piston relative to the cylinder to control the damping device.

It has proven advantageous that the overlap and/or a speed change of the piston relative to the cylinder is continuously changeable during a damping stroke.

According to an advantageous embodiment of the invention, the at least one control piston and the piston are designed as a pressure compensator. An overlap at the flow cross section of the at least one flow channel, preferably of a possibly present fluid outlet opening with a possibly present outlet opening, is reducible in the event of increased pressure of the damping fluid on the at least one control piston and/or in the region of the overlap and/or is increasable in the event of reduced pressure on the at least one control piston and/or in the region of the overlap.

The design as a pressure compensator enables a particularly effective option for adjusting damping characteristics, wherein a particularly compact damping device can be ensured and/or no complex component parts are required.

In order to ensure a constant speed, an excess flow rate can be discharged, for example, via an adjustable metering aperture with a downstream pressure compensator and/or a bypass check valve, which is arranged on a pressure compensator slide, and the volume flow moves the pressure compensator slide in the direction of an outlet. The task of the pressure compensator is to keep the difference between the pressures before and after the measuring aperture at a constant level predetermined by the spring force in order to be able to generate a constant volume flow at the outlet. The pressure in front of the throttle point acts on the end face of the pressure compensator slide and the pressure at the outlet acts on its back side. Due to the permanently occurring force equalization, the pressure compensator position changes with each pressure fluctuation before or after the measuring aperture, wherein the volume flow cross section at the outlet is reduced or increased. Starting from an inlet, the flow in the direction of the outlet can occur with low losses in the sense of a check valve.

The pressure compensator can comprise the task of keeping a volume flow constant as much as possible, independent of pressure and/or temperature. The volume flow can be constant and depend on the volume flow cross section of the throttle aperture. The pressure compensator can be used for inflow and/or outflow controls. In general, a throttle aperture can be provided in conjunction with the pressure compensator and a spring, and throttling can take place at the throttle cross section starting from the inlet in the direction of the outlet. To keep the volume flow constant independent of pressure, the pressure compensator can comprise a control edge which is arranged downstream of the throttle aperture. The pressure compensator can be moved by the spring. If flow occurs through the pressure compensator, an inlet pressure acts on the pressure compensator and shifts it. The volume flow cross section at the control edge of the pressure compensator is reduced and thus the pressure difference at the throttle aperture can be kept constant. The movement of the pressure compensator can stop when there is a force equilibrium. The pressure compensator can continuously compare the pressure difference at the throttle aperture with the values given by spring parameters and/or preload. A constant volume flow can be achieved by continuous adjustment. In general, an adjustment means such as an adjusting screw can be provided by which a degree of volume flow can be changed within adjustable limits. The volume flow starting from the outlet in the direction of the inlet can depend on the cross section of the throttle aperture, in which case the function of the pressure compensator can be switched off. The pressure compensator can be installed upstream and/or downstream of the throttle aperture.

A volume flow valve can act as a pressure compensator, wherein the pressure compensator is designed to be path-dependent so that a path-dependent reference speed is represented. In contrast to damping devices which as a goal cause damping to a speed that no longer exists, this creates a damping device which damps to a desired reference speed.

The pressure compensator can be designed in such a way that the piston is preloaded with a first spring force via at least one further force accumulator and the at least one control piston is preloaded with a further spring force via at least one force accumulator and in the event of a pressure drop—caused by a difference between a fluid pressure in the front region of the fluid chamber and a fluid pressure within the piston and/or the at least one control piston—the first spring force and the second spring force are constantly kept in equilibrium. This generates a specific position of the control piston based on the defined further spring force. Since the volume flow of the damping fluid, which can be associated with the speed of the piston relative to the cylinder, is proportional to the pressure drop, the position of the at least one control piston represents a control signal for the current speed of the piston relative to the cylinder. In other words, the pressure compensator produces a control signal in the form of a control piston position, which is proportional to the speed of the piston relative to the cylinder.

An overlap between the fluid outlet opening and the outlet opening can be adjusted via the respective positions of the at least one control piston, wherein variable flow cross sections for the damping fluid can be continuously changed so that the overlap acts as a controlled power valve of the damping device in order to be able to continuously adapt the flow cross section to the desired speed reference curve.

It has proven advantageous that at least one further force accumulator, preferably a spring, is provided, which is arranged within the cylinder on the piston and/or the at least one control piston to form a preferably linear speed reference curve of the damping device.

The force accumulator preload of the at least one further force accumulator in connection with the piston can define the reference speed of the piston relative to the cylinder. A speed reference profile can be defined depending on the force accumulator force over a piston travel.

An advantageous variant is that the at least one force accumulator, preferably a spring, is provided and is arranged within the piston and/or on the piston and the at least one control piston. Preferably, the at least one force accumulator acts between the piston and a cylinder end face of the at least one control piston and/or the at least one further force accumulator acts between the piston and a cylinder inner wall.

In the prior art, the control signal for the damping performance basically depends on the absolute speed of the piston relative to the cylinder, due to which an adjustment of the speed cannot be sufficiently ensured.

The spring preload of the at least one force accumulator in conjunction with the at least one control piston results in the control signal associated with the damping performance via the at least one control piston depending on the differential speed of the piston relative to the cylinder with respect to the reference speed of the piston relative to the cylinder. This can ensure that the damping device continuously approximates the speed of the piston in the cylinder to the speed reference curve in the sense of a control of both an excess of speed and a lack of speed, so that the amount of the speed difference of damping devices without the at least one control piston is reduced or eliminated.

The at least one force accumulator can be used to adjust the extent to which damping fluid can flow from the front region into the rear region through the piston and/or at which pressure the damping fluid causes an increase or decrease in the flow cross section by changing the overlap and/or the extent to which the increase or decrease in the overlap is generated via the at least one control piston.

It is particularly preferred that during a damping stroke of the damping device by the at least one force accumulator, an overlap at the flow cross section of the at least one flow channel, preferably of a possibly present fluid outlet opening with a possibly present outlet opening, can be changed, and a speed of the piston relative to the cylinder can be increased by increasing the overlap and/or reduced by reducing the overlap.

In one embodiment of the invention, an overlap at the flow cross section of the at least one flow channel can be automatically reduced or eliminated via a speed difference of the piston relative to the cylinder relative to a speed reference curve. The speed difference can be mediated by at least one optionally present further force accumulator and/or the at least one force accumulator in a relative position of the at least one control piston to the piston.

An overlap can be defined by two separate component parts and/or openings which at least partially overlap.

The speed differences between the desired speed of the piston relative to the cylinder—the speed of the piston without the at least one control piston relative to the speed reference curve—form a speed difference curve to be adapted, which is determined by the movement or force action of the movable furniture part on the at least one further force accumulator, wherein in combination of both force accumulators an adjustment of the speed curve—accumulated by the speed difference curve and the speed reference curve—to the speed reference curve determined by the at least one further force accumulator is made possible.

The speed difference of the piston to be reduced or eliminated defines both the input variable and the output variable to be controlled as a control signal for the power valve formed by the at least one control piston.

According to a preferred exemplary embodiment of the invention, an overlap at the flow cross section of the at least one flow channel is changeable automatically by a speed difference of the piston relative to the cylinder relative to a speed reference curve mediated via at least one possibly present additional force accumulator and/or the at least one force accumulator.

It has proven to be advantageous that a speed of the piston during a damping stroke is changeable via a relative position of the at least one control piston with respect to the piston by at least one possibly present additional force accumulator and/or the at least one force accumulator.

Since the adaptation to the speed reference curve can only be achieved via changed positioning of the at least one control piston relative to the piston, no additional components or electronic actuation modules are required apart from the mechanically induced movement of the at least one control piston via the at least one force accumulator.

Furthermore, preferably the at least one further force accumulator and the at least one force accumulator are arranged parallel to one another, preferably in the damping stroke direction. Preferably, the at least one further force accumulator and the at least one force accumulator are arranged coaxially.

This promotes the force transmission between the piston and the at least one control piston, wherein tilting of the at least one control piston relative to the piston is inhibited and a particularly precise control of the damping force or piston speed over the damping stroke distance can be ensured.

In a further embodiment of the present invention, at least one sealing element is provided, and the fluid chamber is delimited at least in regions by the at least one sealing element. Preferably, the piston rod is movable through the at least one sealing element.

In general, further sealing elements can also be arranged, for example on a piston outer lateral surface and/or on a cylinder inner lateral surface.

The at least one sealing element can be in the form of a braking element or a section on the at least one control aperture, for example, wherein complete or partial sealing on a cylinder inner wall is possible. For example, a slight fluid flow via the braking element may be useful for the functionality of the damping device, which functions as a control signal for a power signal (designed as a pressure compensator) on the at least one control piston as a power valve. However, such a sealing element is generally not mandatory.

According to an advantageous embodiment of the invention, the at least one piston rod is movable directly or indirectly by the movable furniture part, preferably via a linear movement, a rotational movement, and/or a pivoting movement, relative to the cylinder.

In general, the damping device can be used in any structural design of furniture and/or movable furniture parts in which movement sequences are to be damped. Particularly preferably, a rotationally induced pivoting movement of a movable furniture part, preferably a furniture flap or the like, is translated directly into a linear movement of the piston rod. In the case of indirect transmission to the piston rod, sliding elements, coated surfaces, transmission devices, and/or control cams are conceivable—but generally not necessary.

Preferably, the sealing element is designed as a braking element and/or acts in the passage direction of the damping fluid parallel to the at least one flow channel and/or the at least one control aperture and/or in the passage direction of the damping fluid acts in series with the at least one flow channel and/or the at least one control aperture.

The at least one control aperture can also be connected in series and/or parallel with respect to the at least one control piston.

Preferably, the damping device comprises a fluid chamber filled with damping fluid, which is delimited at least by the cylinder, by a possibly present sealing element, by the piston, and/or by the piston rod.

It is particularly preferable that the damping device comprises a volume keeping-constant element which keeps the volume available for the damping fluid in the fluid chamber constant in every position of the piston including the piston rod, and/or wherein the sealing element also forms the volume keeping-constant element and is movable relative to the cylinder and is subjected to force on its side facing away from the fluid chamber, preferably by a possibly present further force accumulator.

According to a preferred embodiment of the invention, a groove is formed on an inner wall of the cylinder, through which, during a damping stroke, damping fluid can flow from the front region of the fluid chamber into the rear region of the fluid chamber.

In an exemplary embodiment of the present invention, the at least one control piston is translationally movable relative to the piston and/or the at least one control aperture in the course of a damping stroke, preferably longitudinally path-dependent and/or speed-dependent of the piston.

Alternatively or additionally, the piston and/or the at least one control aperture is designed such that the piston is rotatable relative to the at least one control aperture and/or the at least one control aperture is rotatable relative to the piston within the cylinder in the course of a damping stroke via a longitudinal movement of the piston.

This makes it possible to adapt aa damping performance to the speed of the piston without the need for grooves in the cylinder or further force accumulators, which may have an undesirable effect on the damping characteristics over a damping stroke in specific applications.

Due to the rotation, the at least one control aperture can partially cover the at least one flow channel to reduce a passage cross section. For example, at least one aperture opening and the at least one flow channel are congruent at the beginning of the damping stroke, wherein the damping cross section is reduced in the course of the damping stroke, preferably to 0—in particular in order to adjust a damping performance in the course of the damping.

In addition, there is the positive property that due to the interaction of the at least one control aperture with the at least one flow channel of the piston, the passage cross section or flow cross section for the damping fluid can be adapted to a desired damping characteristic and a passage of the damping fluid can be adjusted in the course of the damping stroke. For example, the at least one control aperture can cover the at least one flow channel to a greater extent starting from a start of a damping stroke—in which a high speed of the piston is generally present—towards an operating position in the region of the end of the damping stroke—in which a low speed of the piston is generally desired—so that the passage cross section for damping is preferably reduced successively and/or, for example, via an aperture opening.

It is particularly preferred that:
the piston comprises at least, preferably exactly, two flow channels, wherein it is preferably provided that the at least two flow channels are arranged symmetrically on an end face of the piston, and/or
the at least one flow channel is arranged on an end face of the piston and/or the at least one control aperture is arranged on the end face of the piston, and/or
the piston and the at least one control aperture are designed to be movement-coupled to one another in the longitudinal direction in the course of the damping stroke and/or to be decoupled from one another in the rotational direction in the course of the damping stroke, and/or
the flow cross section is changeable by a rotation of the piston relative to the at least one control aperture and/or of the at least one control aperture relative to the piston, and/or
the at least one control aperture and the piston are designed to be rotatable relative to one another in such a way that the flow cross section can be reduced in the course of the damping stroke, preferably longitudinally dependent on the path and/or speed of the piston.

Preferably, the damping device comprises a hollow piston rod, by which the piston is rotatable relative to the at least one control aperture, wherein it is preferably provided that the hollow piston rod is arranged, particularly preferably directly, on the piston and/or the hollow piston rod is guided via a slide track, which is particularly preferably arranged on the cylinder and/or twisted.

Preferably, the damping device comprises a magnet, preferably a bar magnet and/or a permanent magnet, by which the at least one control aperture is rotatable relative to the piston. Preferably, the magnet is arranged, particularly preferably directly, on the at least one control aperture and/or the magnet is rotatable via at least one metallic band particularly preferably a steel band, which is particularly preferably arranged on the cylinder.

Preferably, at least two metallic bands are provided and/or the at least one metallic band is arranged twisted on the cylinder.

Preferably, the damping device comprises a spring for applying force to the piston, which spring is arranged on the at least one control aperture, wherein the at least one control aperture is rotatable relative to the piston by means of the spring. Preferably, the spring is firmly connected to the at least one control aperture and/or the at least one control aperture is rotatable via compression of the spring.

It is preferable that the damping device comprises an impeller by which the at least one control aperture is rotatable relative to the piston. Preferably the impeller is arranged, particularly preferably directly, on the at least one control aperture and/or is rotatable via a passage of damping fluid and/or comprises at least two, particularly preferably four, vanes.

It is preferable that the damping device comprises at least one telescopic device, by which the at least one control aperture is rotatable relative to the piston, and preferably the at least one telescopic device is rotatable via a guide, which is particularly preferably twisted and/or arranged on the cylinder, and/or comprises multiple telescopic parts that can be telescoped into one another and/or towards one another.

In one exemplary embodiment, the at least one control piston acts in parallel and/or in series with a possibly present sealing element and/or the at least one control aperture.

According to an advantageous embodiment of the present invention, the at least one control piston can be displaced relative to the at least one piston, in particular automatically via at least one force accumulator, by which a speed of the piston relative to the cylinder is adjusted to a speed reference curve, which is preferably linear and/or defined via at least one further force accumulator. Preferably, at least one fluid outlet opening of the at least one control piston is displaced relative to at least one outlet opening of the piston.

According to a preferred embodiment of the invention:
a speed of the piston during the damping stroke relative to the cylinder can be regulated by an overlap at the flow cross section of the at least one flow channel, preferably at least one possibly present fluid outlet opening with at least one possibly present outlet opening, wherein the overlap defines a flow cross section of the damping fluid and/or the flow cross section is changeable by a relative position of the at least one control piston with respect to the piston,
the overlap and/or a speed change of the piston relative to the cylinder is continuously changed during a damping stroke,
the at least one control piston and the piston are designed as a pressure compensator, wherein an overlap at the flow cross section of the at least one flow channel is reduced in the case of increased pressure of the damping fluid on the at least one control piston and/or in the region of the overlap and/or is increased in the case of reduced pressure on the at least one control piston and/or in the region of the overlap,
during a damping stroke of the damping device by the at least one force accumulator, an overlap at the flow cross section of the at least one flow channel is changed, wherein a speed of the piston relative to the cylinder is increased by an increase in the overlap and/or reduced by a reduction in the overlap,
the overlap at the flow cross section of the at least one flow channel is automatically reduced or eliminated via a speed difference of the piston relative to the cylinder relative to a speed reference curve, wherein the speed difference can be mediated by at least one optionally present further force accumulator and/or the at least one force accumulator in a relative position of the at least one control piston to the piston, and/or
the overlap is automatically changed by a speed difference of the piston relative to the cylinder relative to a speed reference curve, which is mediated via at least one optionally present further force accumulator and/or the at least one force accumulator.

In general, it is arbitrary whether an increase in the flow cross section is achieved by an increase or the relative positioning of the at least one control piston with respect to the piston, wherein both pressure force accumulators and tension force accumulators can be used with any orientation, in particular an arrangement before or after the at least one control piston in the damping stroke direction, relative to the at least one control piston.

### BRIEF DESCRIPTION OF THE DRAWINGS

The features of the device are applicable to the method and vice versa. Further details and advantages of the present invention are explained in more detail below with reference to the drawings, in which:

FIG. 1a shows a damping device according to a particularly preferred exemplary embodiment in a schematic sectional view through a control piston,

FIG. 1b is a diagram illustrating the speed change of a piston of the damping device according to the exemplary embodiment of FIG. 1a,

FIGS. 2a-2e show a preferred embodiment of the control piston in isolation and in a relative position to the piston with diagrams to illustrate forces, speeds, and pressures on the piston or the control piston,

FIGS. 3a-3c show the damping device according to the exemplary embodiment of FIG. 1a during a damping stroke with diagrams to illustrate the speed adjustment and the relationship between pressures and forces on the piston or control piston,

FIGS. 4a-4d are diagrams to illustrate the adaptation of the speed of the piston to a reference speed as well as the forces and pressures acting on the piston or control piston,

FIGS. 5a, 5b show a damping device according to a preferred embodiment having a control piston which is arranged on the outside of the piston, in a sectional view from the side and a perspective sectional view,

FIGS. 6a,6b show the damping device according to the exemplary embodiment of FIG. 5a in a changed relative position of the control piston with respect to the piston,

FIGS. 7a, 7b show a damping device according to a further preferred embodiment having control pistons arranged inside the piston in a sectional view from the side and a perspective sectional view,

FIGS. 8a, 8b show the damping device according to the exemplary embodiment of FIG. 7a in a changed relative position of the control piston with respect to the piston,

FIG. 9 shows a damping device according to a further preferred embodiment, wherein a relative rotation between a control aperture and piston is generated via a bar magnet, in a perspective view with a sectional view and an enlarged detail section,

FIG. 10 shows the damping device according to the exemplary embodiment of FIG. 9 during a damping stroke,

FIGS. 11a-11d show the control aperture and the bar magnet of the damping device according to the exemplary embodiment of FIG. 9 in an exploded view, a perspective view, and a view from the front with the bar magnet hidden in three different positions along the damping stroke,

FIGS. 12a-12c show the control aperture of the damping device according to the exemplary embodiment of FIG. 11a in a perspective view, a view from the front, and a sectional view in different positions along the damping stroke,

FIG. 13 shows a damping device according to a further preferred embodiment, wherein a rotation is generated via a spring, in a perspective sectional view with an enlarged detail section and a sectional view from the side with an enlarged detail section,

FIG. 14 shows the damping device according to the exemplary embodiment of FIG. 13 during the damping stroke,

FIGS. 15a, 15b show the damping device according to the embodiment of FIG. 13 in two different positions during the damping stroke with the spring hidden (or the telescopic device hidden),

FIG. 16 shows a damping device according to a further preferred embodiment, wherein a rotation is generated via a telescopic device, in a perspective sectional view with an enlarged detail section and a sectional view from the side with an enlarged detail section,

FIG. 17 shows the damping device according to the exemplary embodiment of FIG. 16 during a damping stroke,

FIGS. 18a-18c show the telescopic device of the damping device according to the exemplary embodiment of FIG. 16 in a view from the side before and after a damping stroke, in an exploded view and perspective view before the damping stroke, and in a perspective view after the damping stroke,

FIG. 19 shows a damping device according to another preferred embodiment, wherein a rotation is generated via an impeller, in a perspective view and an exploded view,

FIGS. 20a, 20b show the damping device according to the exemplary embodiment of FIG. 19 in a perspective sectional view before and during a damping stroke,

FIGS. 21a, 21b show the damping device according to the exemplary embodiment of FIG. 19 in a sectional view from the side before and during a damping stroke,

FIGS. 22a, 22b show a damping device according to a further preferred embodiment having a control piston arranged inside the piston in a sectional view from the side and a perspective sectional view, and

FIGS. 23a, 23b show the damping device according to the exemplary embodiment of FIG. 22a in a changed relative position of the control piston with respect to the piston,

### DETAILED DESCRIPTION OF THE INVENTION

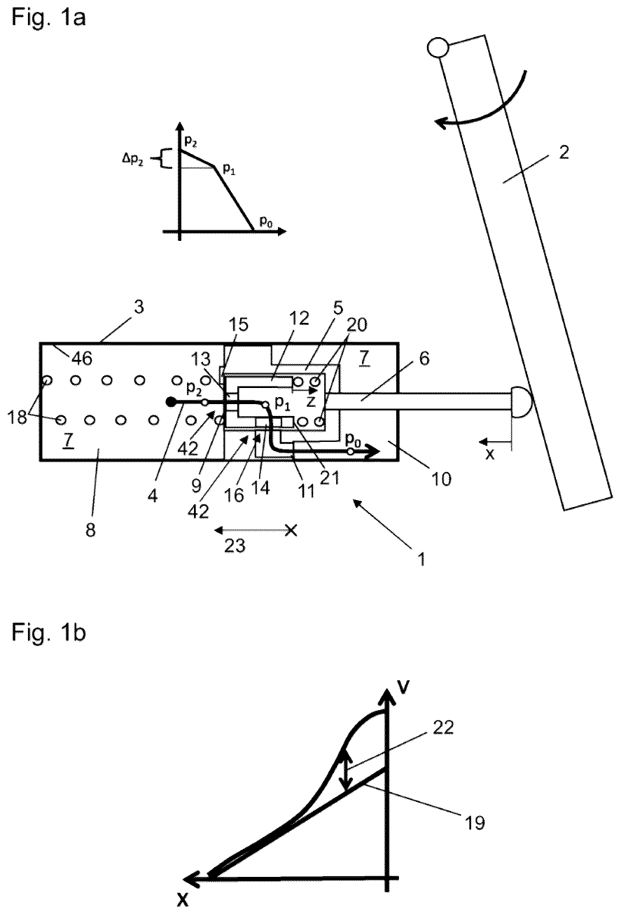

FIG. 1a shows a damping device 1 for damping a movement of a movable furniture part 2, comprising a cylinder 3, a piston 5 guided in the cylinder 3 and damped by a damping fluid 4, a piston rod 6 connected to the piston 5 and a fluid chamber 7 filled with the damping fluid 4, which is delimited at least by the cylinder 3, the piston 5, and the piston rod 6.

The piston 5 comprises an inlet opening 9 facing toward a front region 8 of the fluid chamber 7, wherein the front region 8 is arranged on the side of the piston 5 facing away from the piston rod 6. The piston 5 comprises an outlet opening 11 facing toward a rear region 10 of the fluid chamber 7, wherein the rear region 10 is arranged on the side of the piston 5 facing toward the piston rod 6.

A control piston 12 arranged within the piston 5 is provided in the damping device 1, wherein the control piston 12 is arranged completely within the piston 5. In order to limit and secure the control piston 12 relative to the piston 5, a stop 15 for the control piston 12 is arranged on the piston 5 and faces toward the front region 8.

The control piston 12 comprises a fluid inlet opening 13 facing toward the front region 8 of the fluid chamber 7 and a fluid outlet opening 14 facing toward the rear region 10 of the fluid chamber 7. During a damping stroke of the damping device 1, damping fluid 4 flows from the front region 8 of the fluid chamber 7 via the fluid outlet opening 14 and the outlet opening 11 into the rear region 10 of the fluid chamber 7.

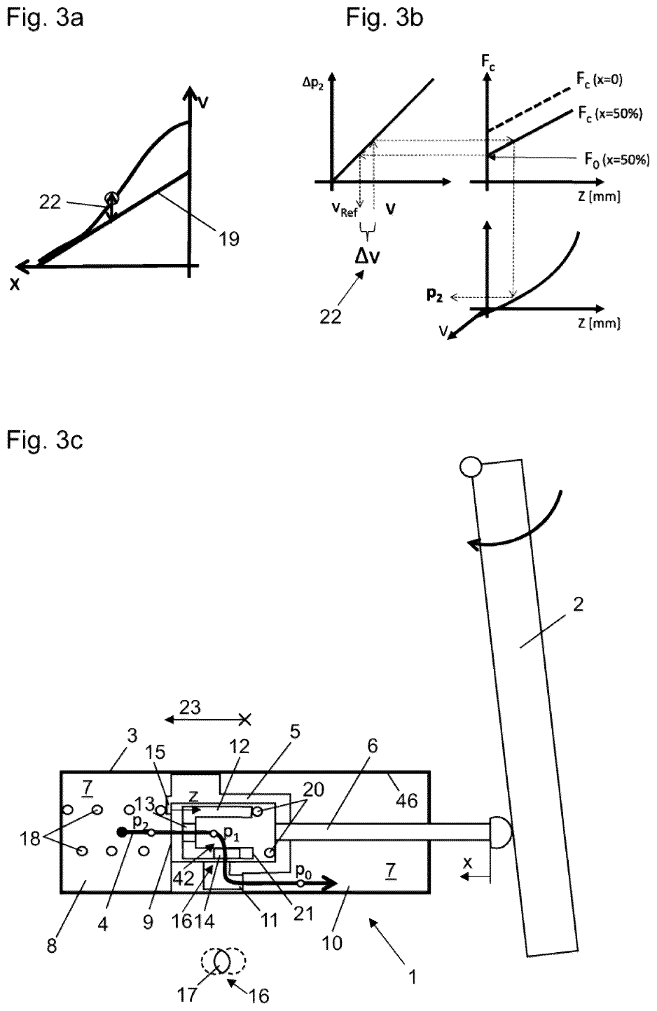

A speed of the piston 5 during the damping stroke relative to the cylinder 3 can be regulated by an overlap 16 of the fluid outlet opening 14 with the outlet opening 11. The overlap 16 corresponds to a flow cross section 17 of the damping fluid 4, wherein the flow cross section 17 is changeable by a relative position of the control piston 12 with respect to the piston 5 (cf. FIG. 3c).

A damping element can be arranged between the control piston 12 and the piston 5 in order to prevent a direct flow of damping fluid 4 from the front region 8 via the outlet opening 11. The control piston 12 is generally adapted with an outer lateral surface to an inner lateral surface of the piston 5 in such a way that damping fluid 4 passes from the front region 8 into the rear region 10 without passing through the fluid outlet opening 14. In general, however, it is conceivable to allow a slight direct passage of the damping fluid 4 from the front region 8 into the rear region 10 without passing through the fluid outlet opening 14 in order to ensure a damping stroke distance of the piston 5 even when there is no overlap 16 between the fluid outlet opening 14 and the outlet opening 11.

On the damping device 1, a further force accumulator 18 in the form of a spring is arranged, which is arranged within the cylinder 3 on the piston 5 to form a linear speed reference curve 19 of the damping device 1. In general, the further force accumulator 18 can alternatively or additionally also be arranged on the control piston 12, wherein it is preferably provided that the further force accumulator 18 is arranged exclusively on the piston 5 with respect to the control piston 12 and the piston 5.

On the damping device 1, a force accumulator 20 designed as a spring is arranged, which is arranged completely within the piston 5. The force accumulator 20 is arranged on the piston 5 and the control piston 12, wherein the force accumulator 20 acts between the piston 5 and a cylinder end face 21 of the control piston 12. The force accumulator 20 ensures a change in the overlap 16 between the fluid outlet opening 14 and the outlet opening 11 in order to regulate the speed of the piston 5 relative to the cylinder.

The overlap 16 is changeable automatically by a speed difference 22 of the piston 5 relative to the cylinder 3 relative to a speed reference curve 19, which is mediated via the further force accumulator 18 and by the force accumulator 20. The speed of the piston 5 during a damping stroke is changeable via a relative position of the control piston 12 with respect to the piston 5 via the further force accumulator 18 and by the force accumulator 20.

The parameter x represents the damping stroke distance of the piston 5 and the parameter z represents a relative movement between the control piston 12 and the piston 5. Above the damping device 1 there is a pressure curve along a flow path of the damping fluid with the parameters p₂ as the pressure in the front region 8, p₁ as the pressure inside the piston 5 (between fluid inlet opening 13 and fluid outlet opening 14), p₀ as the pressure in the rear region 10, and Δp₂ as the difference between p₂ and p₁.

FIG. 1b shows a curve of the speed v of the piston 5 relative to the cylinder 3 over a damping stroke distance x, wherein the speed reference curve 19 with respect to the movement of the piston 5 relative to the cylinder 3 is defined by the further force accumulator 18 during a uniform movement of the movable furniture part 2.

The speed curve of the piston 5 lying above the speed reference curve 19 of the piston 5 is at least approximated to the desired speed reference curve 19 via the damping device 1, wherein the speed curve is preferably adjusted to the speed reference curve 19.

If a speed difference 22 between the current speed of the piston 5 is high, the power valve caused by the control piston 12 acts more strongly than with small speed differences 22. A current difference between the speed curve and the speed reference curve 19 represents the signal for the control piston 12 in order to generate an approximation of the speed curve to the speed reference curve 22.

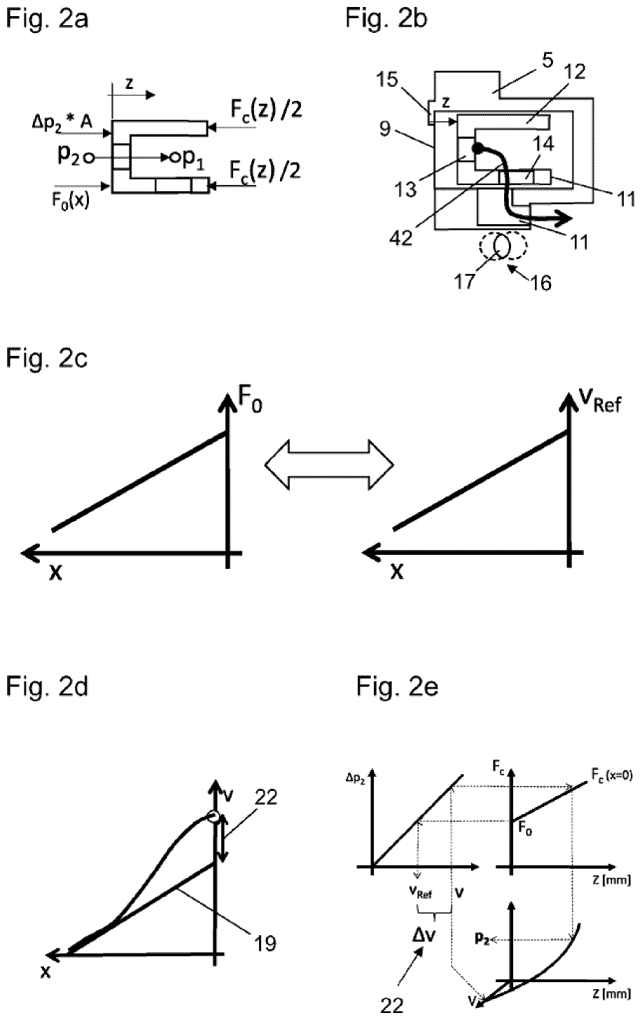

FIG. 2a shows the control piston 12 used for a pressure compensator, wherein the parameter A represents a currently existing flow cross section 17, which is set, for example, at an overlap 16 of 10% in the power valve generated by the fluid outlet opening 14 and outlet opening 11 for controlling the speed of the piston 5.

The control piston 12 and the piston 5 are designed as a pressure compensator, wherein an overlap 16 of the fluid outlet opening 14 and the outlet opening 11 can be reduced in the event of increased pressure of the damping fluid 4 on the control piston 12 or in the region of the overlap 16 and can be increased in the event of reduced pressure on the control piston 12 or in the region of the overlap 16.

The spring force F_{c} of the force accumulator 20 represents a function of the parameter (z) of the relative position between control piston 12 and piston 5. The spring force F₀ of the further force accumulator 18 represents a function of the parameter (x) of the damping stroke distance of the piston 5.

Δp₂ represents the difference between p₂ and p₁, where the functional relationship of Δp₂* is given by F_{c}(z)−F₀(x) divided by the area A of the flow cross section 17 in the form of the overlap 16.

FIG. 2b shows the relative positioning of the control piston 12 with respect to the piston 5 during a damping stroke in which the speed of the piston 5 relative to the cylinder is above a desired speed reference curve 19. The parameter z results on the control piston 12 in such a way that the forces of the two force accumulators 18, 20 remain in equilibrium and represents a control signal for the current speed of the piston 5, since the volume flow of the damping fluid 4 and the associated piston speed are proportional to Δp₂.

FIG. 2c shows a diagram of the spring tension of the further force accumulator 18 as a function of the damping stroke distance x, which defines the speed reference curve 19 of the piston 5 and is indexed by v_{Ref}. Depending on the spring force F₀, the speed reference curve 19 can be defined via the damping stroke distance x of the piston 5. By preloading the force accumulator 20, the control signal of the differential speed for the damping performance is conveyed to the control piston 12. The movement of the piston rod 6 is initiated, for example, by an angular velocity of the movable furniture part 2.

FIGS. 2d to 3b show an application example in which the speed of the piston 5 relative to the cylinder 3 originating from the movable furniture part 2 is higher than the desired speed according to the speed reference curve 19 at the current damping stroke distance position x.

In FIG. 2d, the damping stroke distance x is equal to 0 (indicated by a circle), wherein the damping starts in the direction of the closing position of the movable furniture part 2 and the load case v>v_{Ref} exists. The overlap 16 is 100% in this case. The damping device 1 approaches the reference speed curve 19 depending on the existing speed difference 22, thereby preventing the risk of bounce.

In FIG. 2e, the existing pressure situation in the damping device 1 is shown in comparison to the prevailing force accumulator forces. F₀ represents the force accumulator preload of the further force accumulator 18 at a damping stroke distance x=0.

FIG. 3a differs from FIG. 2d in that a damping stroke distance x of 50% of the maximum damping stroke distance x of the damping device 1 is considered (indexed by a circle). Due to the power valve controlled via the control piston 12 in the region of the overlap 16 for changing the flow cross section 17 (see FIG. 3c), the force accumulator characteristic curve of the further force accumulator 18 changes as a function of F₀ and Fe depending on the damping stroke distance x.

The speed reference curve 19 is a function of the damping stroke distance x, wherein a smaller speed difference 22 results in a smaller relative displacement of the control piston 12 relative to the piston 5 starting from an unloaded position, by which the overlap 16 is increased and the flow cross section 17 is increased. Consequently, the pressure of the damping fluid 4 in the front region 8 is reduced.

FIG. 3b differs from FIG. 2e in that the pressure situation in the damping device 1 is shown in comparison to the prevailing force accumulator forces at a damping stroke distance x of 50%.

FIG. 3c shows the damping device 1, wherein the damping device 1 has been moved in the direction of the closed position of the movable furniture part in relation to FIG. 1a and is located during a damping stroke.

The further force accumulator 18 and the force accumulator 20 are arranged parallel to one another in the damping stroke direction 23, wherein the further force accumulator 18 and the force accumulator 20 are arranged coaxially.

The piston rod 6 is movable directly by the movable furniture part 2 via a rotational movement or a pivot movement relative to the cylinder 3, wherein the piston rod 6 together with the piston 5 executes a linear movement relative to the cylinder 3. In general, an indirect transmission of the movement trajectory of the movable furniture part 2 to the damping device 1—for example in the form of a mechanical transmission mechanism with an adjusting curve or a joint device—is also conceivable.

The movable furniture part 2 is in the form of a furniture flap, although other movable furniture parts 2 such as a drawer with a linear movement in the direction of the damping device 1 are also possible.

In order to adjust the speed of the piston 5 relative to the cylinder 3 to the speed reference curve 19, the overlap 16 and thereby a speed change of the piston 5 relative to the cylinder 3 during the damping stroke is continuously changed via a positioning of the control piston 12 relative to the piston 5.

During the damping stroke of the damping device 1, an overlap 16 of the fluid outlet opening 14 and the outlet opening 11 is changeable by the force accumulator 20, wherein a speed of the piston 5 relative to the cylinder 3 can be increased by increasing the overlap 16 and reduced by reducing the overlap 16.

The overlap 16 can be automatically reduced and eliminated via a speed difference 22 of the piston 5 relative to the cylinder 3 relative to a speed reference curve 19 depending on a position of the control piston 12 relative to the piston 5, since a flow of the damping fluid 4 is regulated. The speed difference 22 is conveyed via the further force accumulator 18 and by the force accumulator 20 in a relative position of the control piston 12 to the piston 5.

By way of example, a method for controlling a damping speed of the damping device 1 during a damping stroke by a damping device 1 can be carried out as follows:
the piston 5 guided in the cylinder 3 and damped by the damping fluid 4 is moved relative to the cylinder 3 by a force applied via the piston rod 6 connected to the piston 5,
damping fluid 4 flows from the front region 8 of the fluid chamber 7 via the inlet opening 9 of the piston 5 into an outlet opening 11 of the piston 5 facing toward the rear region 10 of the fluid chamber 7,
the control piston 12 arranged inside the piston 5 is automatically displaced by the force accumulator 20 relative to the piston 5, by which the fluid outlet opening 14 of the control piston 12 facing toward the rear region 10 of the fluid chamber 7 is displaced relative to the outlet opening 11 of the piston 5 and a speed of the piston 5 relative to the cylinder 3 is adjusted to a linear speed reference curve 19 dependent on the further force accumulator 18.

During the control of the damping speed of the damping device 1 via the control piston 12,
the speed of the piston 5 during the damping stroke relative to the cylinder 3 can be regulated by an overlap 16 of the fluid outlet opening 14 with the outlet opening 11, wherein the overlap 16 defines the flow cross section 17 of the damping fluid 4 and the flow cross section 17 is continuously changed by a relative position of the control piston 12 with respect to the piston 5 during the damping stroke to change the speed of the piston 5,
the control piston 12 and the piston 5 are designed as a pressure compensator, wherein an overlap 16 of the fluid outlet opening 14 and the outlet opening 11 is reduced in the event of increased pressure of the damping fluid 4 on the control piston 12 or in the region of the overlap 16 and is increased in the event of reduced pressure on the control piston 12 or in the region of the overlap 16,
during the damping stroke of the damping device 1, the overlap 16 of the fluid outlet opening 14 and the outlet opening 11 is changed by the force accumulator 20, wherein a speed of the piston 5 relative to the cylinder 3 is increased by increasing the overlap 16 and reduced by reducing the overlap 16,
the overlap 16 is automatically reduced or eliminated via a speed difference 22 of the piston 5 relative to the cylinder 3 relative to the speed reference curve 19, wherein the speed difference 22 is conveyed by a further force accumulator 18 or the force accumulator 20 in a relative position of the control piston 12 to the piston 5,
the overlap 16 is changed automatically by a speed difference 22 of the piston 5 relative to the cylinder 3 relative to a speed reference curve 19, which is mediated via the further force accumulator 18 and by the force accumulator 20.

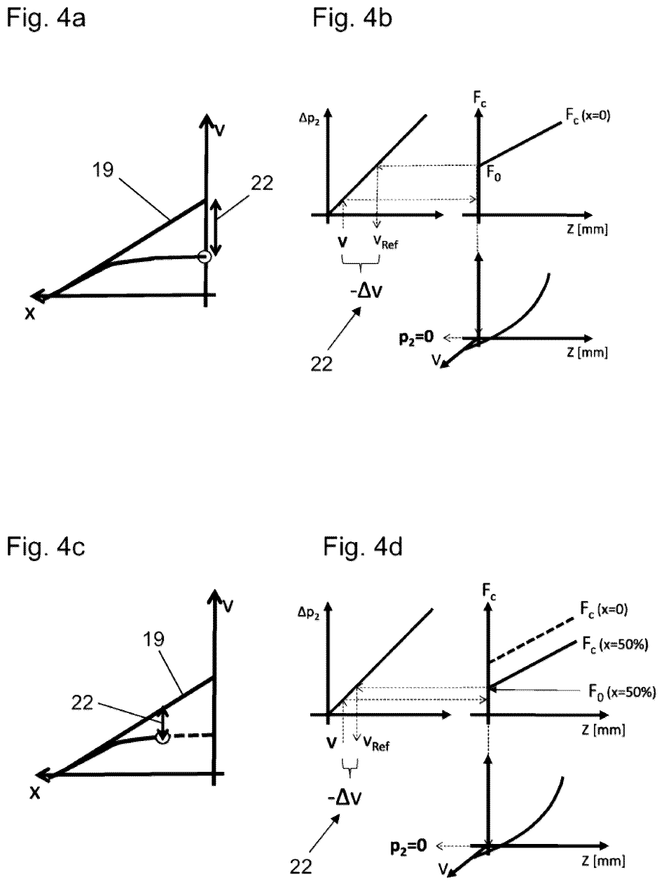

FIGS. 4a to 4d show a further application example of the damping device 1, in which the speed of the piston 5 relative to the cylinder 3 is lower than the desired speed of the speed reference curve 19 at the current damping stroke distance position x.

In FIG. 4a, a damping stroke distance x=0 is considered (indicated by a circle), where a speed difference 22 of the piston 5 relative to the speed reference curve 19 is negative. The overlap 16 is 100% in this case.

FIG. 4b shows the pressure conditions in the fluid chamber 7 and the force ratios of the force accumulator 20 as a function of the relative positioning z of the control piston 12 with respect to the piston 5 at a prevailing speed difference 22. F₀ represents the force accumulator preload of the further force accumulator 18 at a damping stroke distance x=0.

In this configuration of the parameters and location of the control piston 12, the damping device 1 does not generate any damping performance because the speed difference 22 is negative, due to which the speed of the piston 5 relative to the cylinder approaches the speed reference curve 19 due to a speed increase.

In case of an overlap 16 of less than 100%, the overlap 16 would be increased by the force accumulator 20. If the speed difference 22 were positive, a reduction in the piston speed would be generated due to a reduction in the overlap 16 via the force accumulator 20.

FIG. 4c differs from FIG. 4a in that a damping stroke distance x of 50% of the maximum damping stroke distance x is considered. Although the speed difference 22 is lower—due to the lower reference speed v_{Ref} of the speed reference curve 19 at the damping stroke distance x or an already completed approach of the piston speed to the speed reference curve 19, no damping performance is produced by the damping device 1 since the speed difference 22 is still negative.

FIG. 4d differs from FIG. 4b in that the parameters relating to pressure, force accumulator preload, force accumulator force, force accumulator characteristic curve, and speed of the piston 5 relative to the cylinder 3 at half the damping stroke distance x are visible.

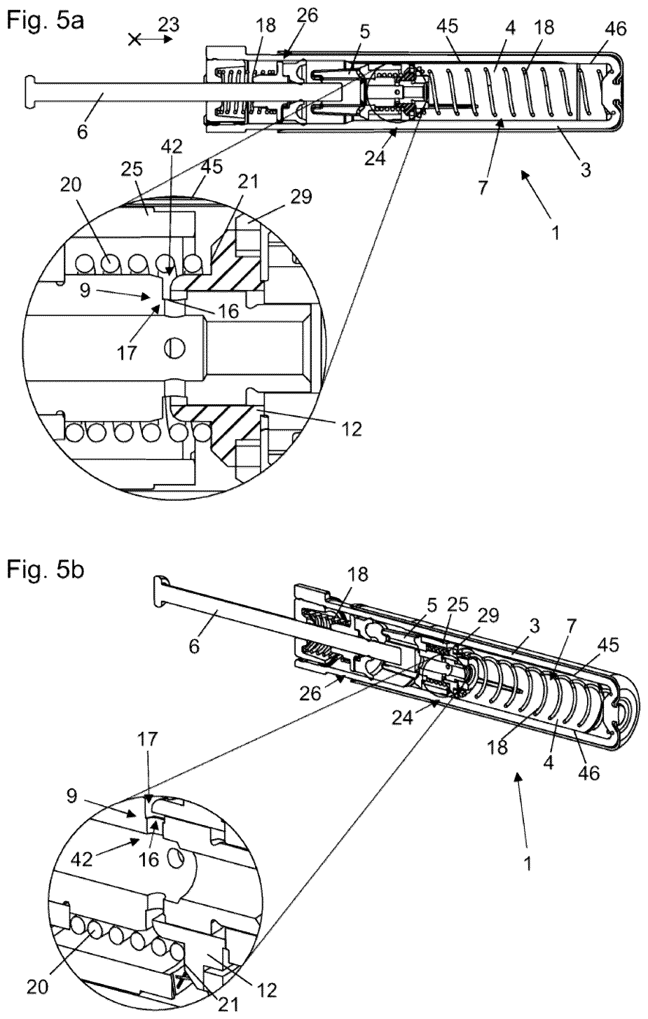

FIG. 5a shows a damping device 1 for a furniture or building fitting, comprising a cylinder 3 in which a damping fluid 4 is arranged, and a piston 5 which can be actuated via a piston rod 6 and which is movable at a speed by the damping fluid 4 in the course of a damping stroke.

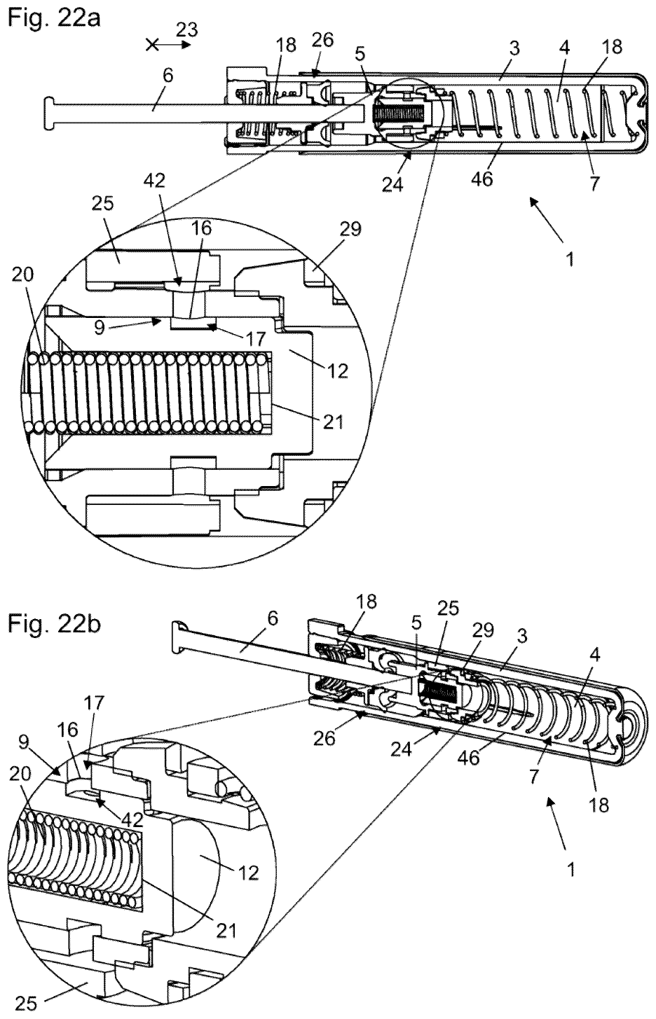

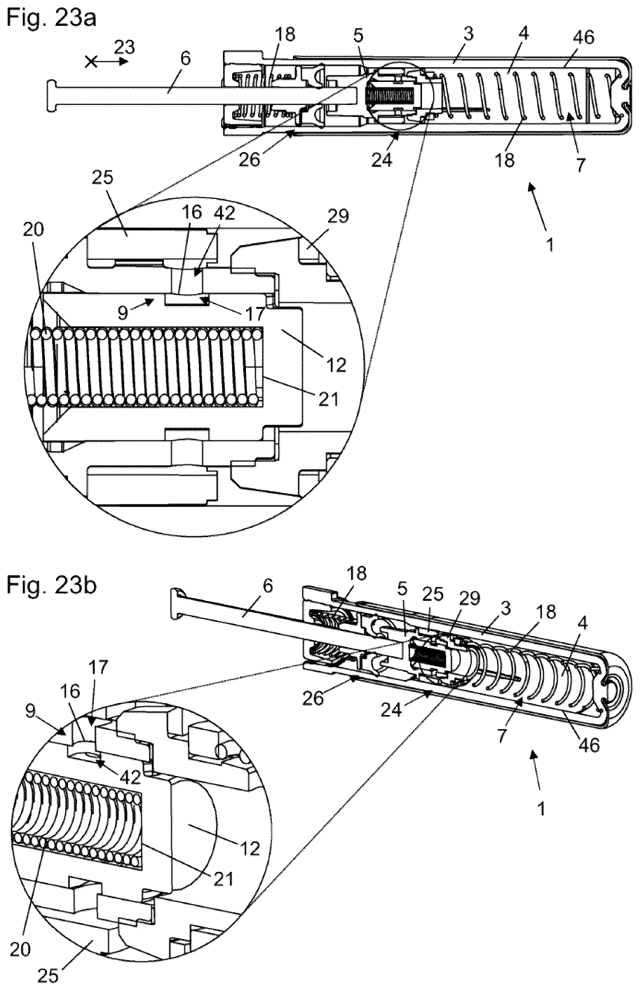

A flow channel 42 (through the piston 5 and control piston 12, wherein generally a flow channel 42 also leads past a braking element 25) having a flow cross section 17 is provided in the damping device 1, through which the damping fluid 4 can pass the piston 5 during the damping stroke. A control piston 12 is provided, which is displaceably mounted on the piston 5 (or in the piston—see FIG. 22a to FIG. 23b), wherein the flow cross section 17 of the flow channel 42 is changeable by a movement of the control piston 12 relative to the piston 5.

A force accumulator 20 is provided on the damping device 1 in the form of a return spring, wherein the force accumulator 20 applies a return force to the control piston 12 relative to the piston 5, which counteracts at least one flow force that can be exerted on the control piston 12 by the damping fluid 4 during the damping stroke.

A pressure drop proportional to the flow force and the speed of the piston 5 occurs at the control aperture 29, wherein a target speed for the piston 5 is predetermined, which depends on a position of the piston 5 relative to the cylinder 3, wherein the control piston 12 is movable relative to the piston 5 against the return force at a speed of the piston 5 which is greater than the target speed, such that the flow cross section 17 of the flow channel 42 can be reduced.

A damping effect is caused by the flow cross section 17, wherein the damping device 1 can be automatically deactivated below the target speed and the target speed for the piston 5, which depends on a position of the piston 5 relative to the cylinder 3, is determined by a further force accumulator 18 (such as spring 28), which applies a force to the control piston 12 against the return force and by a groove 45 in a cylinder inner wall 46 having a changing groove cross section is predetermined. In general, the target speed can also be determined alternatively or additionally by an adjustability of an aperture opening 44 of the control aperture 29.

FIG. 5b shows the damping device 1 according to FIG. 5a only from a different viewing angle.

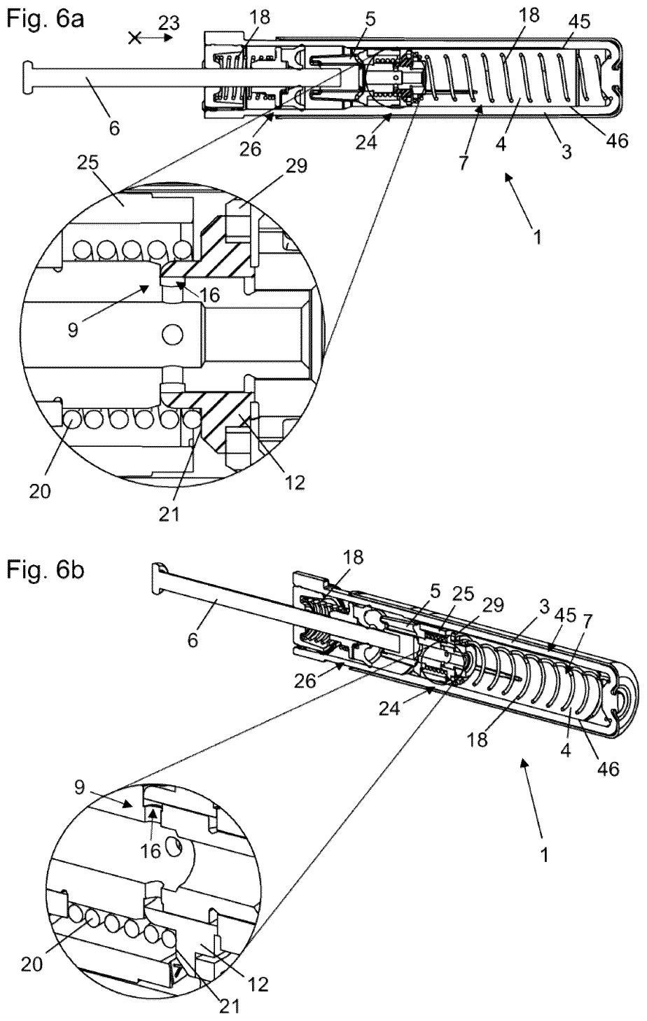

FIG. 6a and FIG. 6b differ from FIG. 5a and FIG. 5b only in that the control piston 12 was displaced relative to the piston 5 in the course of the damping stroke, so that an overlap 16 at the flow cross section 17 of the flow channel 42 was changed in order to adjust a damping performance via a position between the piston 5 and the control piston 12.

The control piston 12 is arranged completely outside the piston 5, but can also be arranged at least in some regions inside the piston 5.

The control piston 12 is in the form of a power valve for the piston 5, wherein the flow cross section 17 of the flow channel 42 is changeable via the control aperture 29 and the control piston 12, so that a speed of the piston 5 is regulated.

The control piston 12 is preloaded relative to the piston 5 by the further force accumulator 18 and the force accumulator 20, and the piston 5 is subjected to force by the further force accumulator 18 to form a desired speed reference curve.

The flow channel 42 is closed or opened by the control piston 12.

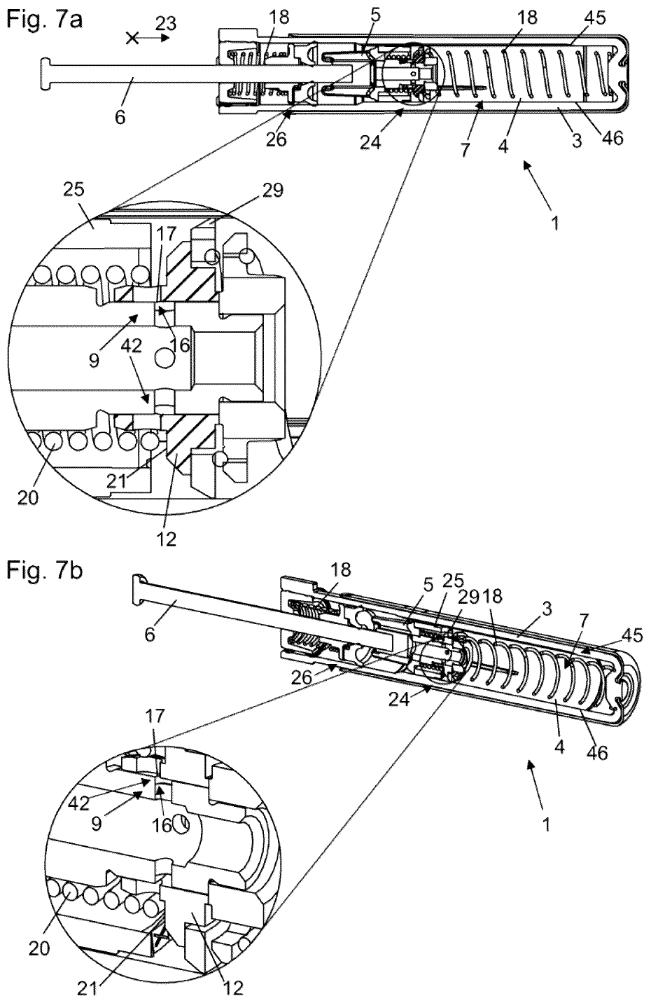

In FIG. 7a, a damping device 1 is shown, wherein the control piston 12 comprises an opening which can be brought into overlap with an opening of the piston 5 in order to increase or reduce a flow cross section 17 of the flow channel 42.

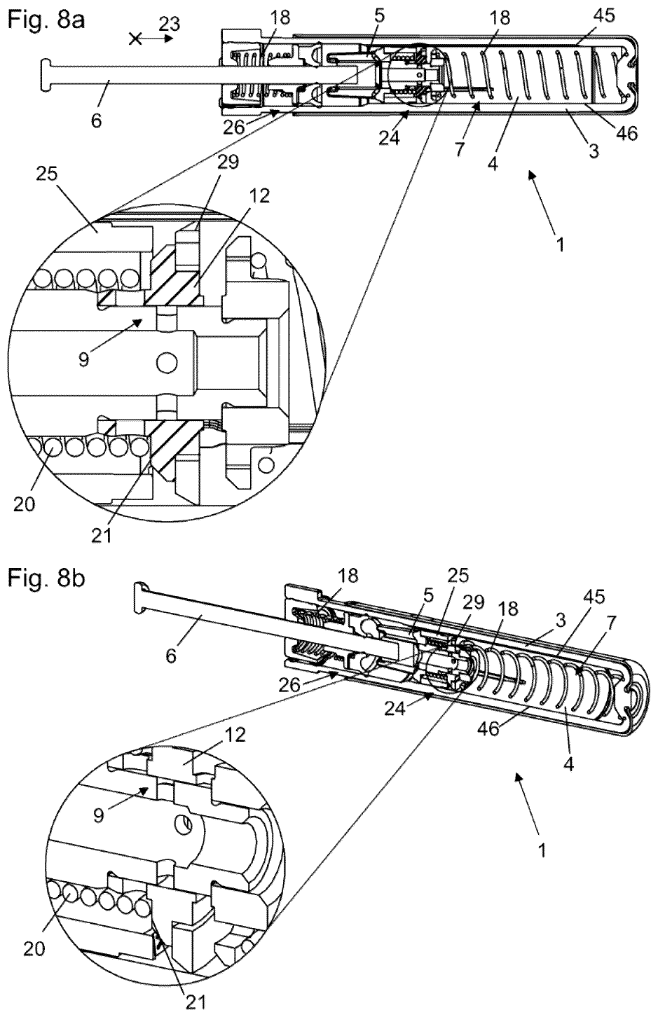

In FIG. 7b, damping fluid 4 can flow into the piston 5, whereas in FIG. 8a and FIG. 8b the flow channel 42 for the damping fluid 4 is closed.

In general, a speed of the piston 5 during the damping stroke relative to the cylinder 3 can be controlled by an overlap 16 at the flow cross section 17 of the flow channel 42—for example between a fluid outlet opening 14 and an outlet opening 11.

The overlap 16 defines the flow cross section 17 of the damping fluid 4 and the flow cross section 17 is changeable by a relative position of the control piston 12 with respect to the piston 5, wherein the flow cross section 17 can also be adjusted at the control aperture 29 or can be used as a control signal for the control piston 12. The overlap 16 and a speed change of the piston 5 relative to the cylinder 3 is continuously changeable during a damping stroke.

The control piston 12 and the piston 5 are designed as a pressure compensator, wherein the overlap 16 at the flow cross section 17 of the flow channel 42 can be reduced in the event of increased pressure of the damping fluid 4 on the control piston 12 and in the region of the overlap 16 and can be increased in the event of reduced pressure on the control piston 12 and in the region of the overlap 16.

As can be seen in FIG. 8b, the further force accumulator 18 is provided in the form of a spring 28 in order to contribute to the formation of an arbitrarily definable speed reference curve 19 of the damping device 1 within the cylinder 3 on the piston 5 and the control piston 12.

During the damping stroke of the damping device 1, an overlap 16 at the flow cross section 17 of the flow channel 42 is changeable by the force accumulator 20, wherein a speed of the piston 5 relative to the cylinder 3 can be increased by increasing the overlap 16 and reduced by reducing the overlap 16. The functional relationships of the component parts are applicable to all exemplary embodiments shown.

The overlap 16 at the flow cross section 17 of the flow channel 42 can be automatically reduced or eliminated via a speed difference 22 of the piston 5 relative to the cylinder 3 relative to a speed reference curve 19, wherein the speed difference 22 can be mediated into a relative position of the control piston 12 to the piston 5 by the further force accumulator 18 and the force accumulator 20. The overlap 16 at the flow cross section 17 of the flow channel 42 is changeable automatically by a speed difference 22 of the piston 5 relative to the cylinder 3 relative to a speed reference curve 19, which is mediated via the further force accumulator 18 and the force accumulator 20. The speed of the piston 5 during a damping stroke is changeable via a relative position of the control piston 12 with respect to the piston 5 by the further force accumulator 18 and the force accumulator 20.

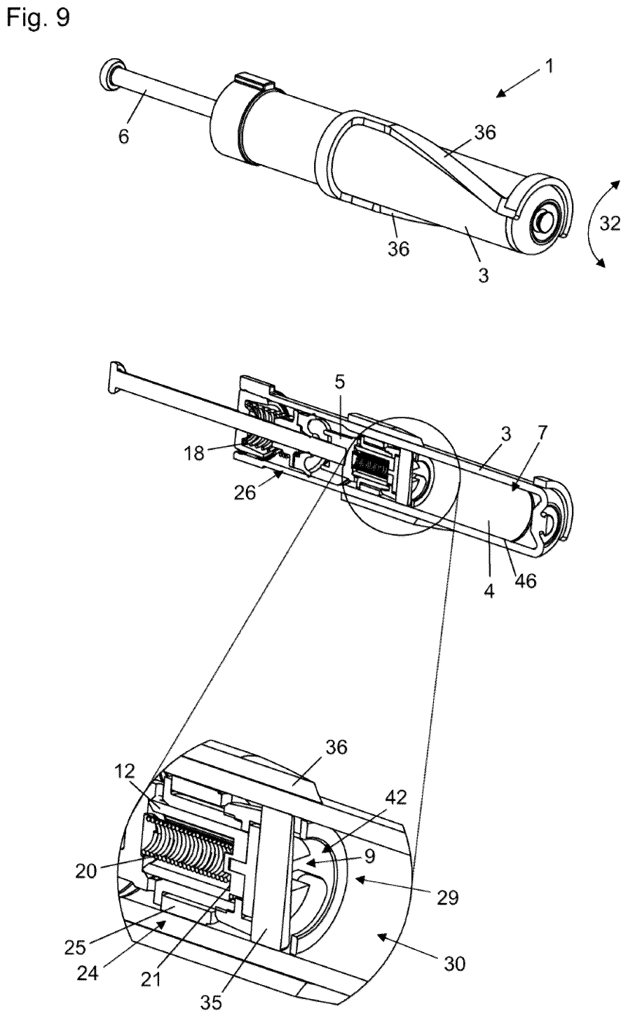

FIG. 9 shows a damping device 1, wherein the damping device 1 comprises a magnet 35 in the form of a bar magnet designed as a permanent magnet in order to rotate the control aperture 29 relative to the piston 5, so that a changed amount of damping fluid 4 flows through the piston 5 and the control piston 12 to change a damping performance.

The control aperture 29 is rotatable relative to the piston 5 by the magnet 35, wherein the magnet 35 is arranged directly on the control aperture 29 and the magnet 35 is rotatable via metallic bands 36 in the form of steel bands arranged at least on the cylinder 3.

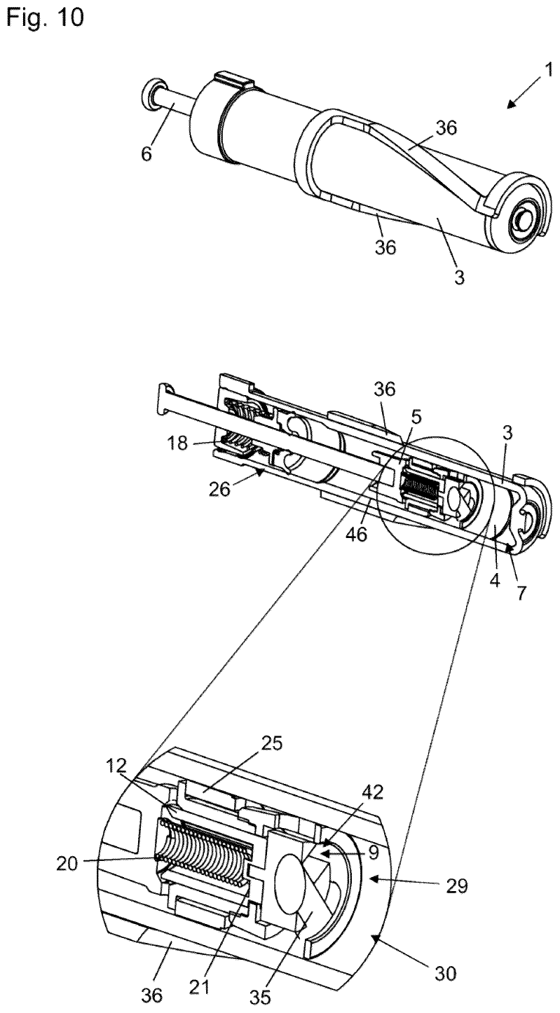

FIG. 10 differs from FIG. 9 only by a changed position of the control aperture 29 relative to the piston.

The two interconnected metallic bands 36 are arranged twisted on the cylinder 3.

The piston 5 comprises exactly two flow channels 42, wherein the flow channels 42 are arranged symmetrically on an end face 30 of the piston 5.

The control aperture 29 is arranged on the end face 30 of the piston 5 and the piston 5 and the control aperture 29 are movement-coupled to one another in the longitudinal direction in the course of the damping stroke and are decoupled from one another in the rotational direction 32 in the course of the damping stroke.

By rotating the piston 5 relative to the control aperture 29 and the control aperture 29 relative to the piston 5, the flow cross section 17 is changeable, wherein the control aperture 29 and the piston 5 are designed to be rotatable relative to one another in such a way that the flow cross section 17 can be reduced (longitudinally path-dependent and speed-dependent) and generally also increased in the course of the damping stroke.

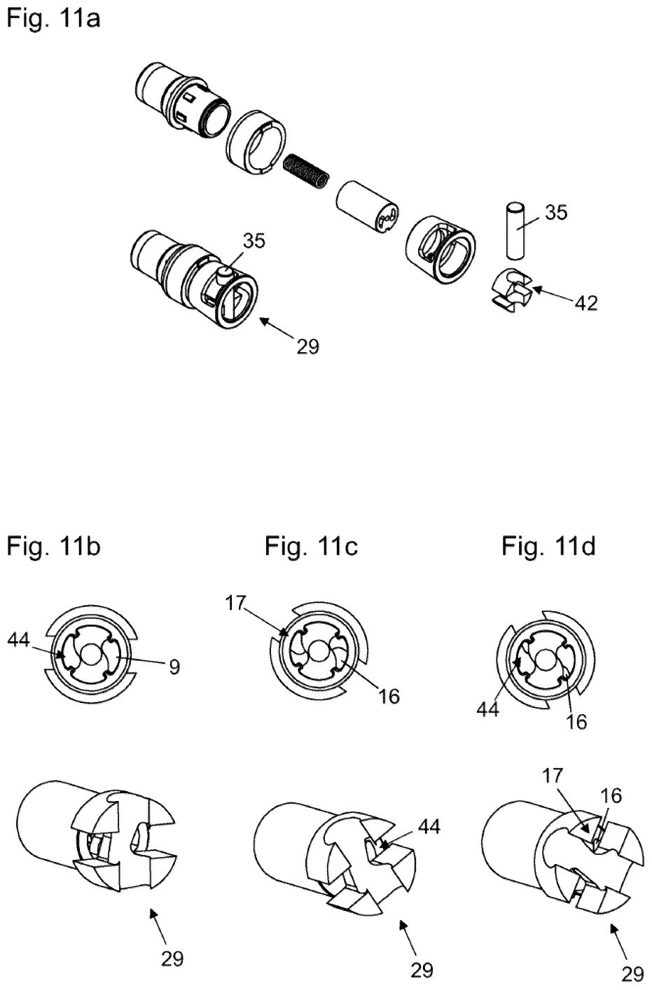

FIG. 11a shows the control aperture 29 in an exploded view and in the assembled state, wherein FIG. 11b to FIG. 11d show three different rotational positions of the control aperture 29—mediated via the magnet 35. Depending on the degree of rotation of the control aperture 29, an aperture opening 44 along a flow channel 42 is increased or reduced in order to adapt a quantity of flowing damping fluid 4 or a pressure so as to maneuver the control piston 29 into the desired location relative to the piston 5.

A rotation angle or a degree of a change of the aperture opening 44 can be generated depending on the position and/or depending on a piston speed.

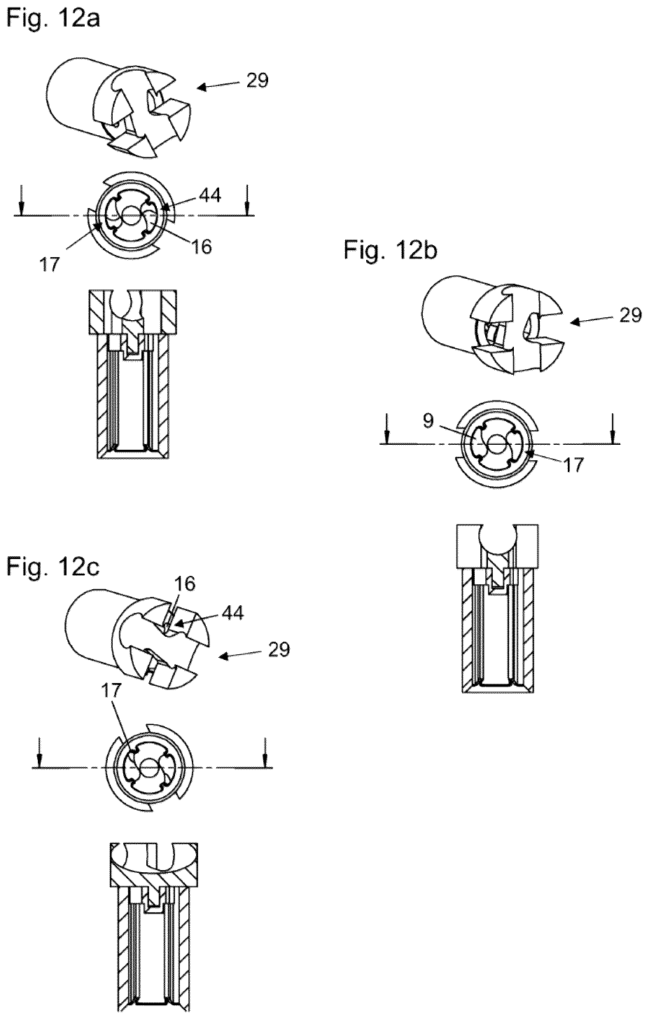

FIG. 12a to FIG. 12c differ from FIG. 11b to FIG. 11d only by an additional sectional view in the three varying flow cross sections 17.

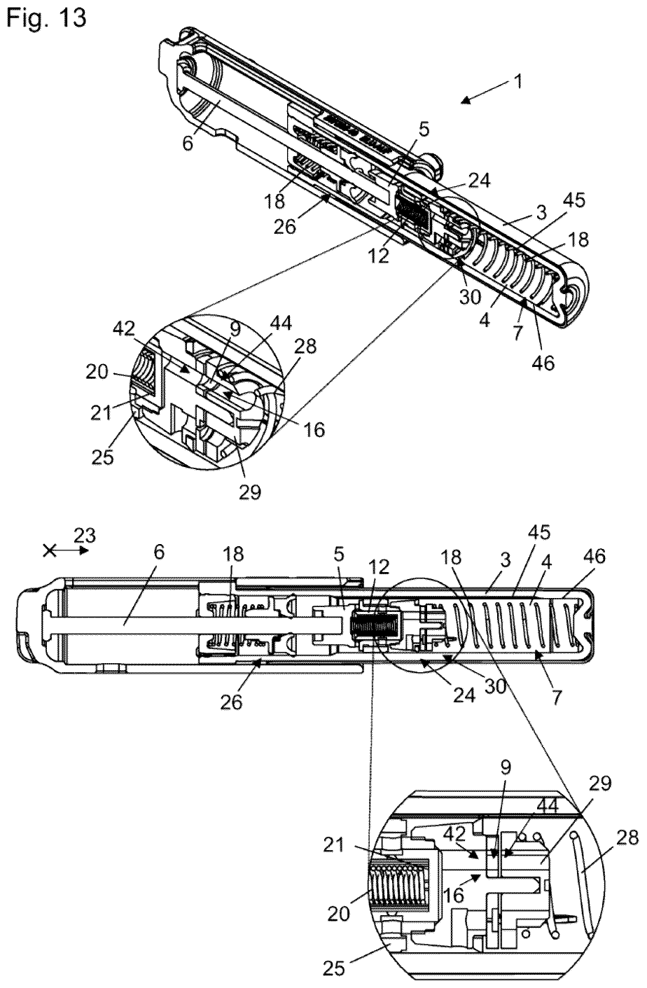

FIG. 13 shows a damping device 1, wherein the damping device 1 comprises a spring 28 for applying force to the piston 5, which is arranged on the control aperture 29, wherein the control aperture 29 is rotatable relative to the piston 5 by the spring 28.

In general, the spring 28 can also be provided only for applying force to the piston 5 or only for rotating the control aperture 29, wherein the combined function of the further force accumulator 18 has proven particularly advantageous for the damping device 1.

The spring 28 is firmly connected to the control aperture 29 and the control aperture 29 is rotatable via a compression of the spring 28.

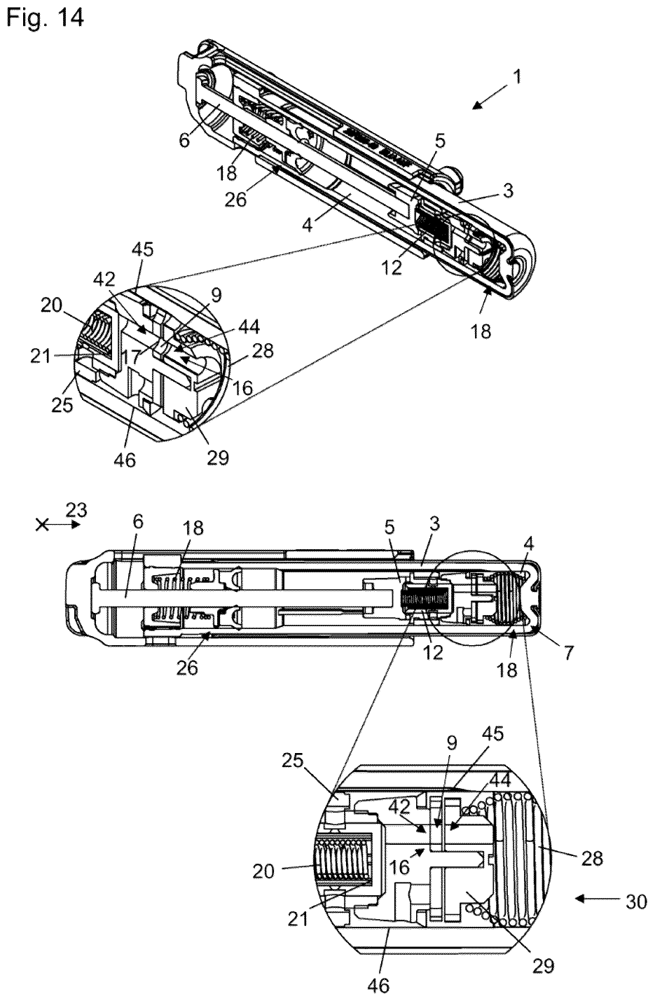

FIG. 14 differs from FIG. 13 only in that the spring 28 is shown in a compressed position after rotation in the course of the damping stroke.

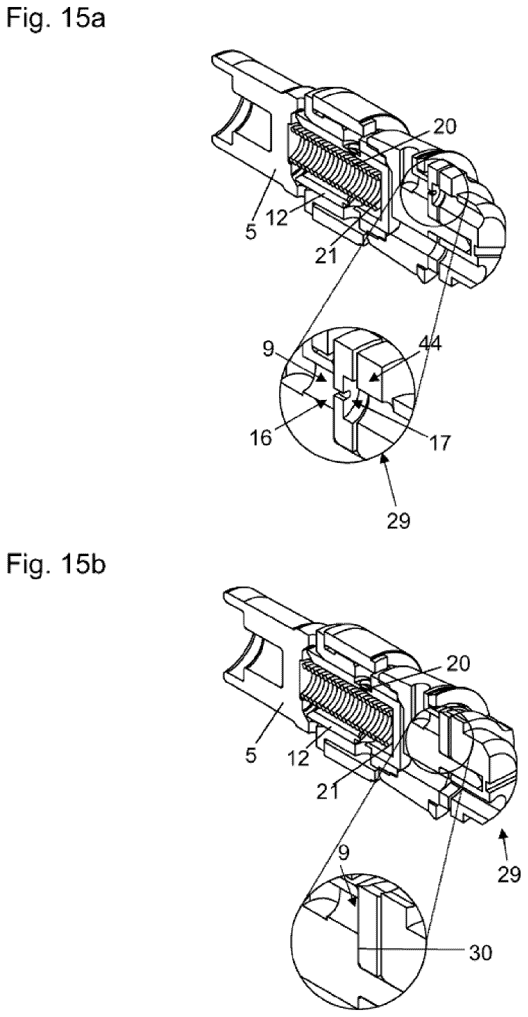

FIG. 15a and FIG. 15b show the piston 5 and the control aperture 29 in two different positions relative to one another, wherein in FIG. 15a a flow cross section 17 of the flow channel 42 for damping fluid 4 is present and in FIG. 15b the overlap 16 is such that no damping fluid 4 can flow into the control piston 12.

A rotation of the control aperture 29 can be caused, for example, by a hollow piston rod (not shown), by means of which the piston 5 is rotatable relative to the control aperture 29. For example, the hollow piston rod can be arranged directly on the piston 5 or can be guided via a twisted guide track arranged on the cylinder 3.

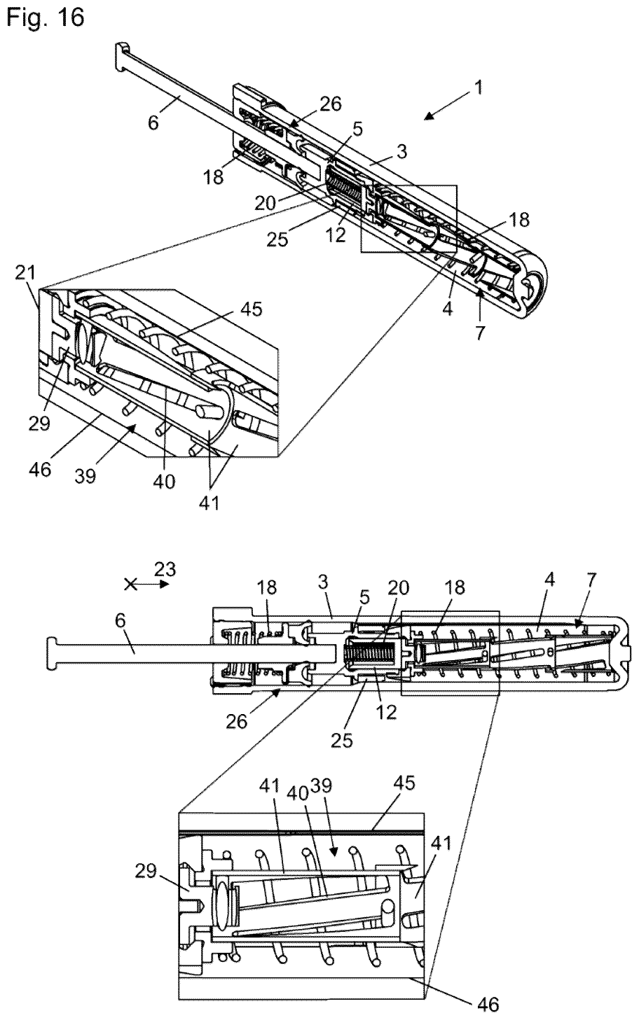

FIG. 16 shows a damping device 1, wherein the damping device 1 comprises a telescopic device 39, by means of which the control aperture 29 is rotatable relative to the piston 5.

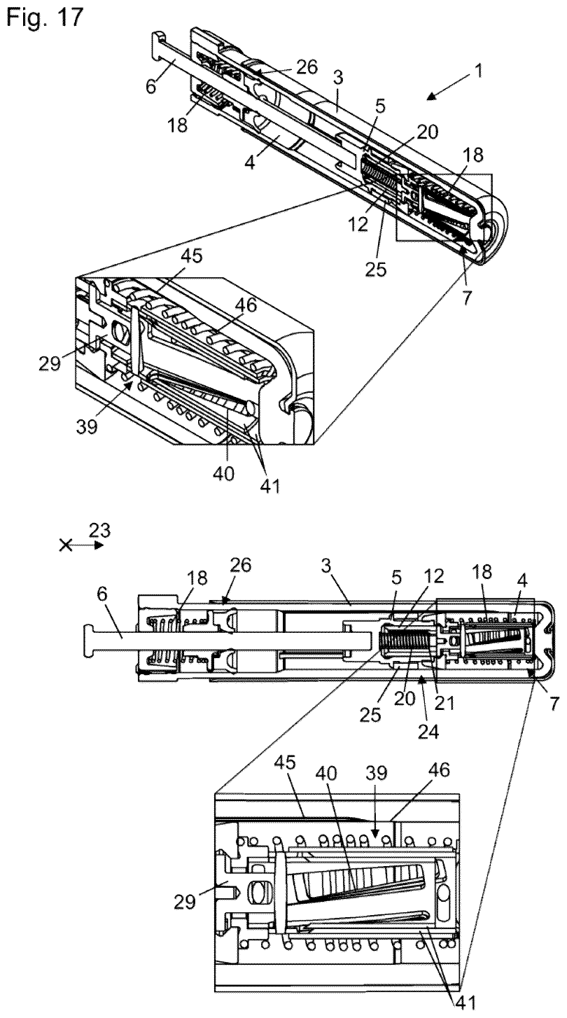

FIG. 17 differs from FIG. 16 only by a changed position along the damping stroke, wherein the telescopic device 39 was rotated via a twisted guide 40 along the telescopic device 39 and comprises multiple telescopic parts 41 which can be telescoped into and towards one another.

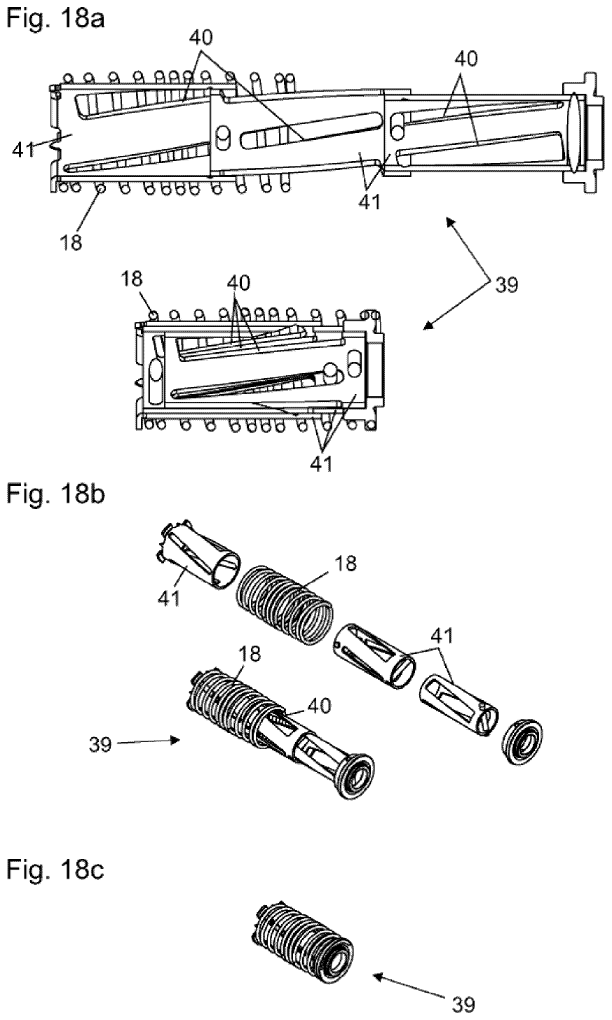

FIG. 18a to FIG. 18c show the guide 40 and the telescopic parts 41 of the telescopic device 39 in isolation in the telescoped-out position and in the telescoped-in position from the side as well as in an exploded view, in the assembled position, and in the compressed state in a perspective view.

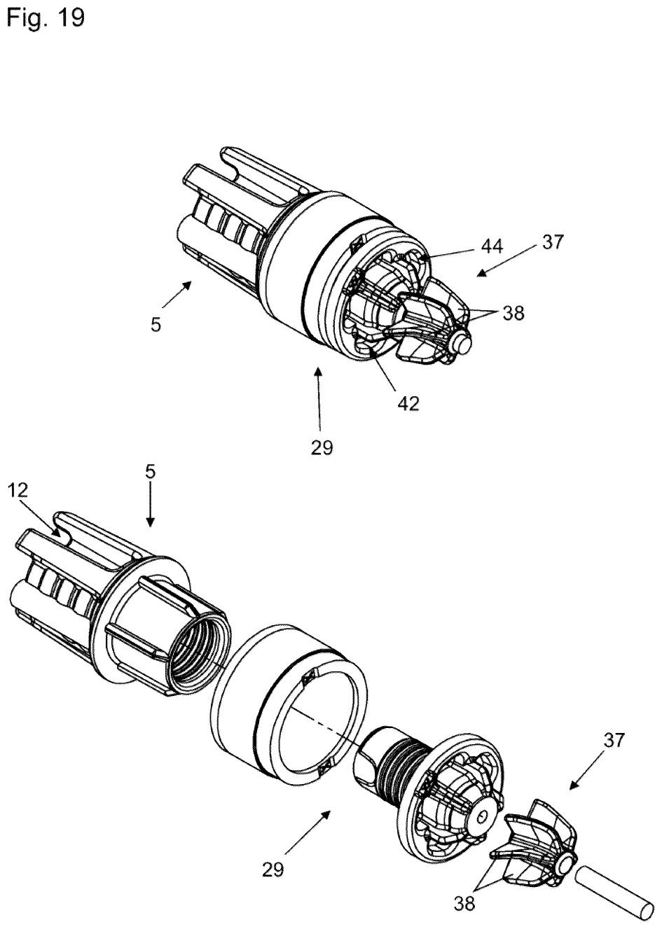

FIG. 19 shows a control aperture 29 for interaction with a piston 5 of a damping device 1, wherein the damping device 1 comprises an impeller 37, by means of which the control aperture 29 is rotatable relative to the piston 5.

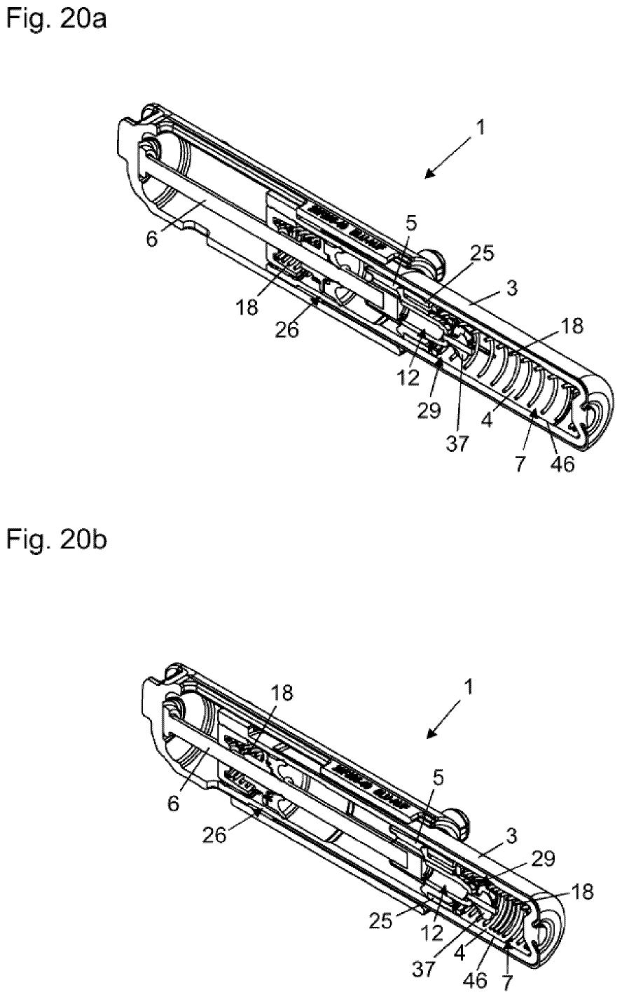

FIG. 20a shows the damping device 1 with impeller 37 in cross sectional view, wherein FIG. 20b differs from FIG. 20a only by a changed position in the damping stroke direction.

The impeller 37 is arranged directly on the control aperture 29 and is rotatable via a passage of damping fluid 4. The impeller 37 comprises a plurality of vanes 38, which can be displaced in the direction of rotation by a flow of damping fluid 4.

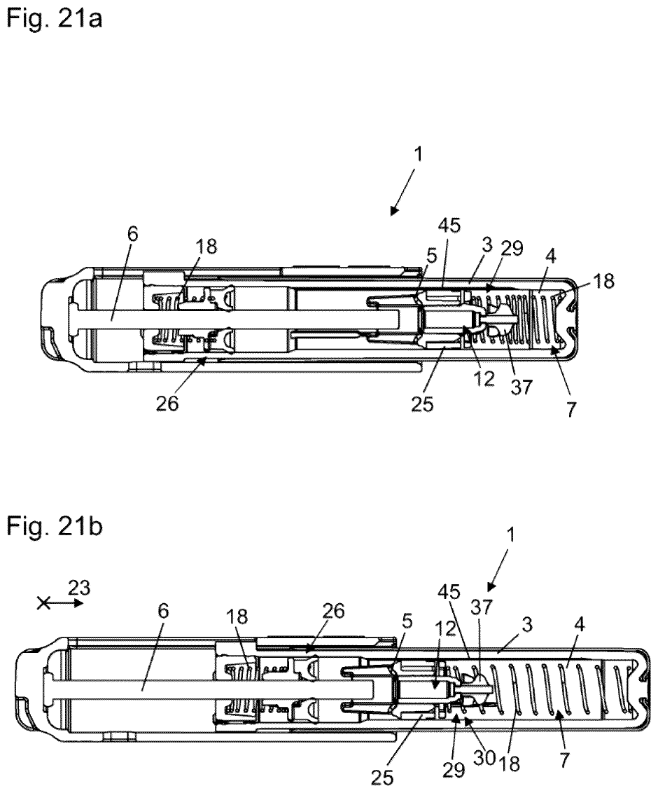

FIG. 21a and FIG. 21b show the damping device 1 having impeller 37 in a sectional view from the side in a position during the damping stroke and in a position before a damping stroke, wherein the control piston 12 is not explicitly shown for reasons of clarity.

The embodiments according to FIG. 9 to FIG. 21b are such that the piston 5 and the control aperture 29 are designed such that the piston 5 is rotatable relative to the control aperture 29 and the control aperture 29 is rotatable relative to the piston 5 within the cylinder 3 in the course of a damping stroke via a longitudinal movement of the piston 5.

FIG. 22a and FIG. 22b show a damping device 1 analogous to the damping devices 1 according to FIG. 5a to FIG. 8b, wherein the control piston 12 is not arranged outside the piston 5, but inside the piston 5. Kinematically, a change in the flow channel 42 at the flow cross section 17 is achievable in an analogous manner by adjusting the overlap 16 between the control piston 12 and the piston 5.

FIG. 23a and FIG. 23b show the damping device 1 according to FIG. 22a and FIG. 22b in a slightly displaced position of the control piston 12 relative to the piston 5, wherein the movement of the movable furniture part (not shown) can be controlled along the damping stroke via a regulation of a damping speed by the damping device 1. Here, at a speed of the movable furniture part 2 relative to the damping device 1 or at a speed of the piston 5 relative to the cylinder 3 which is greater than the target speed, the control piston 12 is moved relative to the piston 5 against the return force (generated by the force accumulator 20) in such a way that the flow cross section 17 of the flow channel 42 is reduced and the movable furniture part 2 or the piston 5 is decelerated to the target speed.

The target speed is predetermined by a force application by the further force accumulator 18 and a position of the control aperture 29 along the cylinder.

At a speed which is lower than the target speed, the damping device 1 is automatically deactivated.

To control the damping strength, the control piston 12 is automatically displaced relative to the piston 5 via the force accumulator 20, by which a speed of the piston 5 relative to the cylinder 3 is adjusted, for example, to a linear speed reference curve 19 or to a speed reference curve 19 defined via the further force accumulator 18. A fluid outlet opening 14 of the control piston 12 can be displaced relative to an outlet opening 11 of the piston 5 depending on the relative location of the control piston 12 and piston 5.

A sealing element 24 of the damping device 1 is designed as a braking element 25 and acts in the direction of passage of the damping fluid 4 parallel to the flow channel 42 on the control piston 12. In exemplary embodiments having a rotationally controlled control aperture 29, the control piston 12 is generally arranged to act in series with the control aperture 29.

The damping device 1 comprises a fluid chamber 7 filled with damping fluid 4, which is delimited by the cylinder 3, by a sealing element 24, by the piston 5, and by the piston rod 6, wherein the damping device 1 comprises a volume keeping-constant element 26, which keeps the volume available for the damping fluid 4 in the fluid chamber 7 constant in every position of the piston 5 including the piston rod 6 and is subjected to force by an additional further force accumulator 18.

The control piston 12 is translationally movable relative to the piston 5 and the control aperture 29 in the course of a damping stroke in a longitudinally path-dependent manner and speed-dependent manner of the piston 5.

1. A damping device for a furniture or building fitting, comprising:
a cylinder in which a damping fluid is arranged,
a piston to be actuated via a piston rod and which is movable through the damping fluid at a speed in the course of a damping stroke, and the piston have at least one flow channel having a flow cross section through which the damping fluid can pass through the piston during the damping stroke,
at least one control piston mounted in and/or on the piston so as to be movable, preferably displaceable, wherein the flow cross section of the at least one flow channel is changeable by a movement of the at least one control piston relative to the piston,
at least one first force accumulator, preferably a return spring, configured to move the at least one control piston relative to the piston with a return force which counteracts at least one flow force which can be exerted by the damping fluid on the at least one control piston during the damping stroke,
at least one control aperture, at which a pressure drop proportional to the flow force and the speed of the piston occurs, wherein a target speed for the piston is predetermined, which is dependent on a position of the piston relative to the cylinder, wherein the at least one control piston is movable relative to the piston against the return force at a speed of the piston which is greater than the target speed, such that the flow cross section of the at least one flow channel can be reduced, preferably wherein the target speed for the piston which is dependent on a position of the piston relative to the cylinder is predetermined by:
at least one second force accumulator, particularly preferably a spring, which applies a force to the at least one control piston counter to the return force, and/or
an adjustability of an aperture opening of the at least one control aperture, and/or
at least one groove in a cylinder inner wall having a changing groove cross section.

2. The damping device according to claim 1, wherein the at least one control piston is arranged outside the piston and/or inside the piston and/or is in the form of a power valve of the piston, wherein it is preferably provided that the flow cross section of the at least one flow channel is changeable via the at least one control aperture and/or by the at least one control piston, so that a speed of the piston can be regulated.

3. The damping device according to claim 1, wherein the at least one control piston is preloaded relative to the piston by the at least one second force accumulator and/or by the at least one first force accumulator and/or the piston can be subjected to force by at least one further force accumulator.

4. The damping device according to claim 1, wherein the piston comprises at least one inlet opening facing toward a front region of a fluid chamber arranged on the side of the piston facing away from the piston rod and at least one outlet opening facing toward a rear region of the fluid chamber arranged on the side of the piston facing toward the piston rod, wherein the at least one control piston comprises at least one fluid inlet opening facing toward the front region of the fluid chamber and at least one fluid outlet opening facing toward the rear region of the fluid chamber, wherein damping fluid can flow from the front region of the fluid chamber into the rear region of the fluid chamber via the at least one fluid outlet opening and the at least one outlet opening during a damping stroke of the damping device.

5. The damping device according to claim 1, wherein the at least one control piston is arranged completely inside or completely outside the piston, wherein it is preferably provided that at least one stop for the at least one control piston, preferably facing toward a front region, is arranged on the piston.

6. The damping device according to claim 1, wherein a speed of the piston during the damping stroke relative to the cylinder can be regulated by an overlap at the flow cross section of the at least one flow channel, preferably a possibly present fluid outlet opening with a possibly present outlet opening, wherein it is preferably provided that the overlap defines a flow cross section of the damping fluid and/or the flow cross section is changeable by a relative position of the at least one control piston with respect to the piston.

7. The damping device according to claim 6, wherein the overlap and/or a speed change of the piston relative to the cylinder is continuously changeable during a damping stroke.

8. The damping device according to claim 1, wherein the at least one control piston and the piston are designed as a pressure compensator, wherein an overlap at the flow cross section of the at least one flow channel, preferably of an optionally present fluid outlet opening with an optionally present outlet opening, can be reduced in the event of increased pressure of the damping fluid on the at least one control piston and/or in the region of the overlap and/or can be increased in the event of reduced pressure on the at least one control piston and/or in the region of the overlap.

9. The damping device according to claim 1, further comprising the at least one second force accumulator, preferably a spring, is provided, which is arranged within the cylinder on the piston and/or the at least one control piston to form a preferably linear speed reference curve of the damping device.

10. The damping device according to claim 1, wherein the at least one force accumulator, preferably a spring, is provided and is arranged within the piston and/or on the piston and the at least one control piston, wherein it is preferably provided that the at least one force accumulator acts between the piston and a cylinder end face of the at least one control piston and/or the at least one second force accumulator acts between the piston and a cylinder inner wall.

11. The damping device according to claim 1, wherein during a damping stroke of the damping device by the at least one force accumulator, an overlap at the flow cross section of the at least one flow channel, preferably of a possibly present fluid outlet opening with a possibly present outlet opening, is changeable, wherein a speed of the piston relative to the cylinder can be increased by increasing the overlap and/or reduced by reducing the overlap.

12. The damping device according to claim 1, wherein an overlap at the flow cross section of the at least one flow channel can be automatically reduced or eliminated via a speed difference of the piston relative to the cylinder relative to a speed reference curve, wherein the speed difference can be mediated by at least one optionally present further force accumulator and/or the at least one force accumulator into a relative position of the at least one control piston to the piston.

13. The damping device according to claim 1, wherein an overlap at the flow cross section of the at least one flow channel is changeable automatically by a speed difference of the piston relative to the cylinder relative to a speed reference curve mediated via at least one optionally present further force accumulator and/or the at least one force accumulator.

14. The damping device according to claim 1, wherein a speed of the piston during a damping stroke is changeable via a relative position of the at least one control piston with respect to the piston by at least one optionally present further force accumulator and/or the at least one force accumulator.

15. The damping device according to claim 1, wherein the at least one second force accumulator and the at least one force accumulator are arranged parallel to one another, preferably in the damping stroke direction, wherein it is preferably provided that the at least one second force accumulator and the at least one force accumulator are arranged coaxially.

16. The damping device according to claim 1, wherein the at least one piston rod is movable directly or indirectly by the movable furniture part, preferably via a linear movement, a rotational movement, and/or a pivoting movement, relative to the cylinder.

17. The damping device according to claim 1, wherein the damping device comprises a sealing element through which the piston rod is movable, wherein the sealing element:
is designed as a braking element, and/or
in the direction of passage of the damping fluid, acts in parallel to the at least one flow channel and/or the at least one control aperture, and/or
in the direction of passage of the damping fluid, acts in series to the at least one flow channel and/or the at least one control aperture.

18. The damping device according to claim 1, wherein the damping device comprises a fluid chamber filled with damping fluid, which is delimited at least by the cylinder, by a possibly present sealing element, by the piston, and/or by the piston rod.

19. The damping device according to claim 17, wherein the damping device comprises a volume keeping-constant element which keeps the volume available for the damping fluid in the fluid chamber constant in every position of the piston including the piston rod, and/or wherein the sealing element also forms the volume keeping-constant element and is movable relative to the cylinder and is subjected to force on its side facing away from the fluid chamber, preferably by a possibly present further force accumulator.

20. The damping device according to claim 1, wherein the at least one control piston is translationally movable relative to the piston and/or the at least one control aperture in the course of a damping stroke, preferably longitudinally path-dependent and/or speed-dependent of the piston.

21. The damping device according to claim 1, wherein the piston and/or the at least one control aperture is designed such that the piston is rotatable relative to the at least one control aperture and/or the at least one control aperture is rotatable relative to the piston within the cylinder in the course of a damping stroke via a longitudinal movement of the piston.

22. The damping device according to claim 21, wherein:
the piston comprises at least, preferably exactly, two flow channels, wherein it is preferably provided that the at least two flow channels are arranged symmetrically on an end face of the piston, and/or
the at least one flow channel is arranged on an end face of the piston and/or the at least one control aperture is arranged on the end face of the piston, and/or
the piston and the at least one control aperture are designed to be movement-coupled to one another in the longitudinal direction in the course of the damping stroke and/or to be decoupled from one another in the rotational direction in the course of the damping stroke, and/or
the flow cross section is changeable by a rotation of the piston relative to the at least one control aperture and/or of the at least one control aperture relative to the piston, and/or
the at least one control aperture and the piston are designed to be rotatable relative to one another in such a way that the flow cross section can be reduced in the course of the damping stroke, preferably longitudinally dependent on the path and/or speed of the piston.

23. The damping device according to claim 21, further comprising a hollow piston rod, by which the piston is rotatable relative to the at least one control aperture, wherein it is preferably provided that the hollow piston rod is arranged, particularly preferably directly, on the piston and/or the hollow piston rod is guided via a slide track, which is particularly preferably arranged on the cylinder and/or is twisted.

24. The damping device according to claim 21, further comprising a magnet, preferably a bar magnet and/or a permanent magnet, by which the at least one control aperture is rotatable relative to the piston, wherein it is preferably provided that the magnet is arranged, particularly preferably directly, on the at least one control aperture and/or the magnet is rotatable via at least one metallic band, particularly preferably a steel band, which is particularly preferably arranged on the cylinder.

25. The damping device according to claim 24, wherein at least two metallic bands are provided and/or the at least one metallic band is arranged twisted on the cylinder.

26. The damping device according to claim 21, further comprising a spring for applying force to the piston, which is arranged on the at least one control aperture, wherein the at least one control aperture is rotatable relative to the piston by means of the spring, wherein it is preferably provided that the spring is firmly connected to the at least one control aperture and/or the at least one control aperture is rotatable via compression of the spring.

27. The damping device according to claim 21, further comprising an impeller, by which the at least one control aperture is rotatable relative to the piston, wherein it is preferably provided that the impeller is arranged, particularly preferably directly, on the at least one control aperture and/or is rotatable via a passage of damping fluid and/or comprises at least two, particularly preferably four, vanes.

28. The damping device according to claim 21, further comprising at least one telescopic device, by which the at least one control aperture is rotatable relative to the piston, wherein it is preferably provided that the at least one telescopic device is rotatable via a guide, which is particularly preferably twisted and/or arranged on the cylinder, and/or comprises multiple telescopic parts that can be telescoped into one another and/or towards one another.

29. The damping device according to claim 1, wherein the at least one control piston acts parallel and/or in series with a possibly present sealing element and/or the at least one control aperture.

30. A method for controlling a movement of a movable furniture part via regulation of a damping speed by the damping device according to claim 1, wherein at a speed of the movable furniture part relative to the at least one damping device and/or at a speed of the piston relative to the cylinder which is greater than the target speed, the at least one control piston is moved relative to the piston against the return force in such a way that the flow cross section of the at least one flow channel is reduced and the movable furniture part and/or the piston is decelerated to the target speed, wherein it is provided in particular that the at least one damping device is inactive at a speed which is less than the target speed.

31. The method according to claim 30, wherein the at least one control piston, in particular automatically via at least one force accumulator, is displaced relative to the at least one piston, by which a speed of the piston relative to the cylinder is adjusted to a speed reference curve, which is preferably linear and/or defined via the at least one second force accumulator, wherein it is preferably provided that at least one fluid outlet opening of the at least one control piston is displaced relative to at least one outlet opening of the piston.

32. The method according to claim 31, wherein:
a speed of the piston during the damping stroke relative to the cylinder can be regulated by an overlap at the flow cross section of the at least one flow channel, preferably at least one possibly present fluid outlet opening with at least one possibly present outlet opening, wherein the overlap defines a flow cross section of the damping fluid and/or the flow cross section is changeable by a relative position of the at least one control piston with respect to the piston,
the overlap and/or a speed change of the piston relative to the cylinder is continuously changed during a damping stroke,
the at least one control piston and the piston are designed as a pressure compensator, wherein an overlap at the flow cross section of the at least one flow channel is reduced in the case of increased pressure of the damping fluid on the at least one control piston and/or in the region of the overlap and/or is increased in the case of reduced pressure on the at least one control piston and/or in the region of the overlap,
during a damping stroke of the damping device by the at least one force accumulator, an overlap at the flow cross section of the at least one flow channel is changed, wherein a speed of the piston relative to the cylinder is increased by an increase in the overlap and/or reduced by a reduction in the overlap,
the overlap at the flow cross section of the at least one flow channel is automatically reduced or eliminated via a speed difference of the piston relative to the cylinder relative to a speed reference curve, wherein the speed difference can be mediated by at least one optionally present further force accumulator and/or the at least one force accumulator in a relative position of the at least one control piston to the piston, and/or
the overlap is automatically changed by a speed difference of the piston relative to the cylinder relative to a speed reference curve, which is mediated via at least one optionally present further force accumulator and/or the at least one force accumulator.

33. A use of a damping device according to claim 1 in a movable furniture part, a door, and/or a window.

34. A piece of furniture comprising the damping device according to claim 1, wherein at least one movable furniture part can be damped by the at least one damping device relative to a furniture body between an open position and a closed position.

35. A door comprising the damping device according to claim 1, wherein the door can be damped relative to a door frame by the at least one damping device between an open position and a closed position.

36. A window comprising the damping device according to claim 1, wherein the window can be damped relative to a window frame by the at least one damping device between an open position and a closed position.
